(19) United States
(12) Patent Application Publication
(10) Pub. No.: US 2024/0064069 A1
(43) Pub. Date: Feb. 22, 2024

(54) DATA OBTAINING METHOD AND SYSTEM, AND APPARATUS THEREOF

(71) Applicant: HUAWEI TECHNOLOGIES CO., LTD., Shenzhen (CN)

(72) Inventor: Zhuoming LI, Xi’an (CN)

(21) Appl. No.: 18/500,491

(22) Filed: Nov. 2, 2023

Related U.S. Application Data
(63) Continuation of application No. PCT/CN2022/088689, filed on Apr. 24, 2022.

(30) Foreign Application Priority Data
May 6, 2021 (CN) 202110494318.X

(51) Int. Cl. H04L 41/5009; H04L 43/065; H04L 43/0817

(52) U.S. Cl. CPC H04L 41/5009; H04L 43/065; H04L 43/0817

(57) ABSTRACT

Embodiments of this application disclose a data obtaining method and system, and an apparatus thereof. The method includes: A network data analytics network element determines a data source to which to-be-obtained data belongs; determines, based on first information, an object identifier that is of the data source and that is in an operation, administration, and maintenance OAM system; and sends a first request to the OAM system. The first request includes the object identifier, and the first request is for requesting to obtain the to-be-obtained data. In this manner, a process in which the network data analytics network element obtains data of a managed object from the OAM system can be simplified.

### CROSS-REFERENCE TO RELATED APPLICATIONS

This application is a continuation of International Application No. PCT/CN2022/088689, filed on Apr. 24, 2022, which claims priority to Chinese Patent Application No. 202110494318.X, filed on May 6, 2021. The disclosures of the aforementioned applications are incorporated herein by reference in these entireties.

### TECHNICAL FIELD

This application relates to the field of communications technologies, and in particular, to a data obtaining method and system, and an apparatus thereof.

### BACKGROUND

An operation, administration, and maintenance (OAM) system may be configured to analyze, predict, plan, configure, test, and perform fault management on a network and a service. The OAM system performs the foregoing management operation and maintenance operation on the network and the service, and may generate a large amount of data about the network and the service.

Currently, if an NWDAF needs to obtain data of a managed object in the OAM system, the NWDAF needs to have an entire database of managed objects of the OAM system. As a result, a process in which the NWDAF obtains the data of the managed object from the OAM system is complex.

### SUMMARY

Embodiments of this application provide a data obtaining method and system, and an apparatus thereof, to simplify a process in which an NWDAF obtains data of a managed object from an OAM system.

According to a first aspect, an embodiment of this application provides a data obtaining method. An execution body of the method may be a network data analytics network element, or may be a chip used in the network data analytics network element. The method includes: The network data analytics network element determines a data source to which to-be-obtained data belongs; obtains first information, where the first information is for determining an object identifier that is of the data source and that is in an OAM system; determines, based on the first information, the object identifier that is of the data source and that is in the operation, administration, and maintenance OAM system; and sends a first request to the OAM system. The first request includes the object identifier, and the first request is for requesting to obtain the to-be-obtained data. It should be noted that the first information may be for associating an identifier of the data source with the object identifier that is of the data source and that is in the OAM system, or may be for associating a domain name of the data source with the object identifier that is of the data source and that is in the OAM system. The first information may also be referred to as association information.

In this technical solution, the network data analytics network element may determine, based on the first information, the object identifier that is of the data source and that is in the OAM system. In this manner, the network data analytics network element does not need to obtain an entire database of managed objects of the OAM system, so that a process in which the network data analytics network element obtains data from the OAM system is simplified.

In an implementation, the first information includes a correspondence between an identifier of the data source and the object identifier that is of the data source and that is in the OAM system.

In this technical solution, the object identifier that is of the data source and that is in the OAM system may be obtained by querying the correspondence, so that the process in which the network data analytics network element obtains the data from the OAM system is simplified.

In an implementation, the data source includes a network slice or a network slice subnet.

In an implementation, the first information is included in a network function profile. The network function profile includes one or more of the following: a correspondence between an identifier of the network slice and an object identifier that is of the network slice and that is in the OAM system; a correspondence between an identifier of the network slice and an object identifier that is of the network slice subnet in the network slice and that is in the OAM system; a correspondence between an identifier of the network slice subnet in the network slice and an object identifier that is of the network slice and that is in the OAM system; or a correspondence between an identifier of the network slice subnet in the network slice and an object identifier that is of the network slice subnet and that is in the OAM system.

In an implementation, the to-be-obtained data is a key performance indicator KPI of the network slice or a KPI of the network slice subnet.

In an implementation, the first information includes a generation rule of the object identifier that is of the data source and that is in the OAM system. A specific implementation in which the network data analytics network element determines, based on the first information, the object identifier that is of the data source and that is in the OAM system may be: The network data analytics network element generates, based on the generation rule and an identifier of the data source, the object identifier that is of the data source and that is in the OAM system.

In this technical solution, when the data source is a network slice or a network slice subnet, even if a network slice or a network slice subnet is newly added, an object identifier that is of the (newly added) network slice or network slice subnet and that is in the OAM system may be generated based on the historically obtained generation rule.

In an implementation, the object identifier includes a first identifier and a second identifier, and the generation rule includes a first generation rule and a second generation rule. A specific implementation in which the network data analytics network element generates, based on the generation rule and an identifier of the data source, the object identifier that is of the data source and that is in the OAM system may be: The network data analytics network element generates the first identifier based on the first generation rule and a domain name of the network data analytics network element, and generates the second identifier based on the second generation rule and the identifier of the data source.

In an implementation, an identifier of the data source includes network slice selection assistance information and/or a network slice subnet identifier. The object identifier that is of the data source and that is in the OAM system includes a managed object identifier relating to network slice managed object identifier and/or a managed object identifier relating to network slice subnet.

In an implementation, the method further includes: The network data analytics network element receives a second request, where the second request is for requesting to perform data analytics. The network data analytics network element receives the to-be-obtained data from the OAM system, and performs data analytics based on the to-be-obtained data, to obtain an analytics result. A specific implementation in which the network data analytics network element determines a data source to which to-be-obtained data belongs may be: The network data analytics network element determines, based on the second request, the data source to which the to-be-obtained data belongs.

In an implementation, the second request includes an identifier of the data source.

In an implementation, the first information includes a mapping rule between a domain name of the data source and the object identifier that is of the data source and that is in the OAM system. The method further includes: The network data analytics network element obtains the domain name of the data source. A specific implementation in which the network data analytics network element determines, based on the first information, the object identifier that is of the data source and that is in the OAM system may be: The network data analytics network element obtains, through mapping from the domain name of the data source according to the mapping rule, the object identifier that is of the data source and that is in the OAM system.

In an implementation, the object identifier includes a third identifier and a fourth identifier. The first information specifically includes a first mapping rule between the domain name of the data source and the third identifier and a second mapping rule between a host name of the data source and the fourth identifier. The method further includes: The network data analytics network element obtains the host name of the data source. A specific implementation in which the network data analytics network element obtains, through mapping from the domain name of the data source according to the mapping rule, the object identifier that is of the data source and that is in the OAM system may be: The network data analytics network element obtains the third identifier through mapping from the domain name of the data source according to the first mapping rule, and obtains the fourth identifier through mapping from the host name of the data source according to the second mapping rule.

In an implementation, a specific implementation in which the network data analytics network element obtains the domain name of the data source may be: The network data analytics network element sends a third request to a network repository function NRF network element, where the third request is for requesting to obtain the domain name of the data source, and the network data analytics network element receives the domain name of the data source from the NRF network element.

In an implementation, that the network data analytics network element obtains first information includes any one of the following: The network data analytics network element obtains the first information from the OAM system or the NRF network element; the network data analytics network element obtains a network function profile from the OAM system or the NRF network element, where the network function profile includes the first information; or the network data analytics network element obtains the first information from a memory of the network data analytics network element.

In an implementation, the network function profile is a configuration file of the network data analytics network element or a network slice selection network element.

In an implementation, the data source includes one or more of the following: a network element, an interface of the network element, or configuration data of the network element.

According to a second aspect, an embodiment of this application provides another data obtaining method, used in an operation, administration, and maintenance OAM system. The system includes a management device. An execution body of the method may be the management device, or may be a chip used in the management device. The method includes: The management device generates first information, and sends the first information to a first network element. The first information is for determining an object identifier that is of a data source to which to-be-obtained data belongs and that is in the OAM system.

In this technical solution, the first information is sent to the first network element. The first network element may be a network data analytics network element. Alternatively, the network data analytics network element may obtain the first information from the first network element, so that the network data analytics network element may determine, based on the first information, the object identifier that is of the data source and that is in the OAM system. In this manner, the network data analytics network element does not need to obtain an entire database of managed objects of the OAM system, so that a process in which the network data analytics network element obtains data from the OAM system is simplified.

In an implementation, the first information includes a correspondence between an identifier of the data source and the object identifier that is of the data source and that is in the OAM system.

In an implementation, the data source includes a network slice or a network slice subnet.

In an implementation, the first information is included in a network function profile. The network function profile includes one or more of the following: a correspondence between an identifier of the network slice and an object identifier that is of the network slice and that is in the OAM system; a correspondence between an identifier of the network slice and an object identifier that is of the network slice subnet in the network slice and that is in the OAM system; a correspondence between an identifier of the network slice subnet in the network slice and an object identifier that is of the network slice and that is in the OAM system; or a correspondence between an identifier of the network slice subnet in the network slice and an object identifier that is of the network slice subnet and that is in the OAM system.

In an implementation, the to-be-obtained data is a key performance indicator KPI of the network slice or a KPI of the network slice subnet.

In an implementation, the first information includes a generation rule of the object identifier that is of the data source and that is in the OAM system.

In an implementation, the object identifier includes a first identifier and a second identifier. The generation rule includes a first generation rule and a second generation rule. The first generation rule includes a rule of generating the first identifier based on a domain name of a network data analytics network element. The second generation rule includes a rule of generating the second identifier based on an identifier of the data source.

In an implementation, an identifier of the data source includes network slice selection assistance information and/or a network slice subnet identifier. The object identifier that is of the data source and that is in the OAM system includes a managed object identifier relating to network slice managed object identifier and/or a managed object identifier relating to network slice subnet.

In an implementation, the first information includes a mapping rule between a domain name of the data source and the object identifier that is of the data source and that is in the OAM system.

In an implementation, the object identifier includes a third identifier and a fourth identifier. The first information specifically includes a first mapping rule between the domain name of the data source and the third identifier and a second mapping rule between a host name of the data source and the fourth identifier.

In an implementation, a specific implementation in which the management device sends the first information to a first network element may be: The management device sends a configuration command to the first network element, where the configuration command includes the first information. Alternatively, the management device sends network function profile to the first network element, where the network function profile includes the first information.

In an implementation, the network function profile is a configuration file of the network data analytics network element or a network slice selection network element.

In an implementation, the data source includes one or more of the following: a network element, an interface of the network element, or configuration data of the network element.

In an implementation, the first network element includes one or more of the following: the network slice selection network element, a network repository function NRF network element, or the network data analytics network element.

According to a third aspect, an embodiment of this application provides a communications apparatus. The communications apparatus has a part or all of functions of implementing the network data analytics network element in the method example in the first aspect. For example, a function of the communications apparatus may include a function of a part or all of embodiments of this application, or may include a function of independently implementing any embodiment of this application. The function may be implemented by hardware, or may be implemented by hardware executing corresponding software. The hardware or the software includes one or more units or modules corresponding to the functions.

In an implementation, a structure of the communications apparatus may include a processing unit and a communications unit. The processing unit is configured to support the communications apparatus in performing a corresponding function in the foregoing method. The communications unit is configured to support communication between the communications apparatus and another device. The communications apparatus may further include a storage unit. The storage unit may be coupled to the processing unit and a sending unit, and the storage unit stores a computer program and data that are necessary for the communications apparatus.

In an implementation, the communications apparatus includes: a processing unit, configured to determine a data source to which to-be-obtained data belongs, obtain first information, and determine, based on the first information, an object identifier that is of the data source and that is in an operation, administration, and maintenance OAM system; and a communications unit, configured to send a first request to the OAM system, where the first request includes the object identifier, and the first request is for requesting to obtain the to-be-obtained data.

In an example, the processing unit may be a processor, the communications unit may be a transceiver or a communications interface, and the storage unit may be a memory.

In an implementation, the communications apparatus includes: a processor, configured to determine a data source to which to-be-obtained data belongs, obtain first information, and determine, based on the first information, an object identifier that is of the data source and that is in an operation, administration, and maintenance OAM system; and a transceiver, configured to send a first request to the OAM system, where the first request includes the object identifier, and the first request is for requesting to obtain the to-be-obtained data.

According to a fourth aspect, an embodiment of this application provides another communications apparatus. The communications apparatus has a part or all of functions of implementing the management device in the method example in the second aspect. For example, a function of the communications apparatus may include a function of a part or all of embodiments of this application, or may include a function of independently implementing any embodiment of this application. The function may be implemented by hardware, or may be implemented by hardware executing corresponding software. The hardware or the software includes one or more units or modules corresponding to the functions.

In an implementation, a structure of the communications apparatus may include a processing unit and a communications unit. The processing unit is configured to support the communications apparatus in performing a corresponding function in the foregoing method. The communications unit is configured to support communication between the communications apparatus and another device. The communications apparatus may further include a storage unit. The storage unit may be coupled to the processing unit and a sending unit, and the storage unit stores a computer program and data that are necessary for the communications apparatus.

In an implementation, the communications apparatus includes: a processing unit, configured to generate first information, where the first information is for determining an object identifier that is of a data source to which to-be-obtained data belongs and that is in the OAM system; and a communications unit, configured to send the first information to a first network element.

In an example, the processing unit may be a processor, the communications unit may be a transceiver or a communications interface, and the storage unit may be a memory.

In an implementation, the communications apparatus includes: a processor, configured to generate first information, where the first information is for determining an object identifier that is of a data source to which to-be-obtained data belongs and that is in the OAM system; and a transceiver, configured to send the first information to a first network element.

According to a fifth aspect, an embodiment of this application provides a data obtaining system. The system includes one or more communications apparatuses in the third aspect and the fourth aspect.

According to a sixth aspect, an embodiment of the present invention provides a computer-readable storage medium. The computer-readable storage medium stores a computer program, the computer program includes program instructions, and when the program instructions are executed by a communications apparatus, the communications apparatus is enabled to perform the method in the first aspect.

According to a seventh aspect, an embodiment of the present invention provides a computer-readable storage medium. The computer-readable storage medium stores a computer program, the computer program includes program instructions, and when the program instructions are executed by a communications apparatus, the communications apparatus is enabled to perform the method in the second aspect.

According to an eighth aspect, this application further provides a computer program product including a computer program. When the computer program product runs on a computer, the computer is enabled to perform the method in the first aspect.

According to a ninth aspect, this application further provides a computer program product including a computer program. When the computer program product runs on a computer, the computer is enabled to perform the method in the second aspect.

According to a tenth aspect, this application provides a chip system. The chip system includes at least one processor and an interface, and is configured to support a network data analytics network element in implementing a function in the first aspect, for example, determining or processing at least one of data and information in the foregoing method. In a possible design, the chip system further includes a memory, and the memory is configured to store a computer program and data that are necessary for the network data analytics network element. The chip system may include a chip, or may include a chip and another discrete component.

According to an eleventh aspect, this application provides a chip system. The chip system includes at least one processor and an interface, and is configured to support a management device in an OAM system in implementing a function in the second aspect, for example, determining or processing at least one of data and information in the foregoing method. In a possible design, the chip system further includes a memory, and the memory is configured to store a computer program and data that are necessary for the management device. The chip system may include a chip, or may include a chip and another discrete component.

### BRIEF DESCRIPTION OF DRAWINGS

FIG. 1a is a schematic diagram of a network architecture of a 5G system;

FIG. 1B is a schematic diagram of a tree structure according to an embodiment of this application;

FIG. 1c is a schematic diagram of another tree structure according to an embodiment of this application;

FIG. 1d is a schematic diagram of a system architecture to which an embodiment of this application is applied;

FIG. 2 is a schematic flowchart of a data obtaining method according to an embodiment of this application;

FIG. 3 is a schematic flowchart of another data obtaining method according to an embodiment of this application;

FIG. 4a is a schematic flowchart of still another data obtaining method according to an embodiment of this application;

FIG. 4b is a schematic diagram of compositions of an object identifier that is of a data source and that is in an OAM system according to an embodiment of this application;

FIG. 5 is a schematic flowchart of still another data obtaining method according to an embodiment of this application;

FIG. 6 is a schematic diagram of a structure of a communications apparatus according to an embodiment of this application;

FIG. 7 is a schematic diagram of a structure of another communications apparatus according to an embodiment of this application; and

FIG. 8 is a schematic diagram of a structure of a chip according to an embodiment of this application.

### DESCRIPTION OF EMBODIMENTS

For ease of understanding, terms involved in this application are first described.

1. Network Architecture of a 5^{th} Generation (5G) Communications System

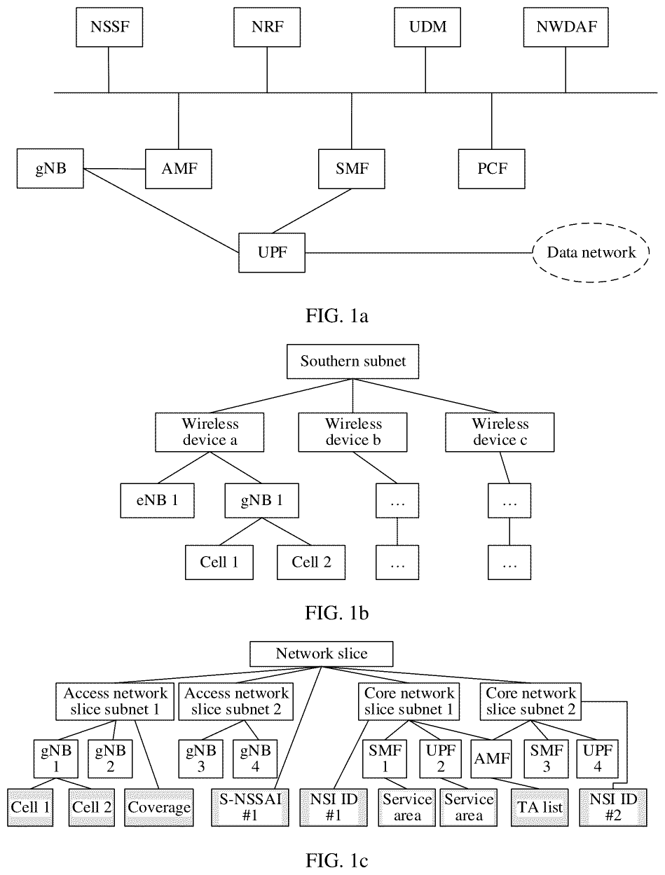

FIG. 1a is a schematic diagram of a network architecture of a 5G system. The architecture may include an access network (AN) and a core network.

The AN is configured to implement an access-related function, may provide a network access function for an authorized user in a specific area, and can determine transmission tunnels of different quality based on a user level, a service requirement, or the like, to transmit user data. The AN forwards a control signal and user data between a terminal device and the core network. The AN may include an AN device. The AN device may be a device that provides access for the terminal device, and may include a radio access network (RAN) device and an AN device. The (R)AN device is mainly responsible for functions such as radio resource management, quality of service (QoS) management, and data compression and encryption on an air interface side. The (R)AN device may include base stations in various forms, for example, a macro base station, a micro base station (which may also be referred to as a small cell), a relay station, an access point, and a balloon station. A possible deployment form of the (R)AN device includes a central unit (CU)-distributed unit (DU) split scenario and a single-site scenario. In the split scenario, the CU may support a protocol such as radio resource control (RRC) protocol, a packet data convergence protocol (PDCP), or a service data adaptation protocol (SDAP). The DU may support a radio link control (RLC) layer protocol, a media access control (MAC) layer protocol, or a physical layer protocol. In systems using different radio access technologies, names of a device having a base station function may be different. For example, in a 5G system, the device is referred to as a (R)AN or a next-generation node base station (next-generation NodeB, gNB). In a long term evolution (LTE) system, the device is referred to as an evolved NodeB (eNB or eNodeB).

The core network is responsible for maintaining subscription data of a mobile network, and provides functions such as session management, mobility management, policy management, and security authentication for user equipment (UE). The core network may include the following network elements: a network data analytics network element, a network slice selection network element, a network repository function (NRF) network element, a unified data management (UDM) network element, an access and mobility management function (AMF) network element, a user plane function (UPF) network element, a session management function (SMF) network element, a policy control function (PCF) network element, an application function (AF) network element, and a network exposure function (NEF) network element.

The network data analytics network element may be configured to collect data from a network function (NF) network element and an operation, administration, and maintenance (OAM) system, and perform data analytics and/or prediction based on the obtained data. In the 5G communications system, the network data analytics network element may be a network data analytics function (NWDAF) network element.

The network slice selection network element is configured to select an appropriate network slice for a service of a terminal. In the 5G communications system, the network slice selection network element may be a network slice selection function (NSSF) network element.

The NRF network element mainly provides service registration, discovery, and authorization, and maintains available network function (NF) instance information, to implement on-demand configuration of a network function and a service and interconnection between NFs. The service registration means that an NF network element can provide a service only after being registered with the NRF network element. The service discovery means that when an NF network element needs to be served by another NF network element, the NF network element first needs to perform service discovery by using the NRF network element, to discover the expected NF network element that serves the NF network element. For example, when an NF network element 1 needs to be served by an NF network element 2, the NF network element 1 first needs to perform service discovery by using the NRF network element, to discover the NF network element 2.

The UDM network element is configured to manage user data, for example, subscription data or authentication/authorization data.

The AMF network element is mainly responsible for mobility management in a mobile network, such as user location update, registration of a user with a network, or user switching.

The UPF network element is mainly responsible for forwarding and receiving user data. The UPF network element may receive the user data from a data network, and transmit the user data to UE by using an access network device, and may further receive the user data from the UE by using the access network device, and forward the user data to the data network.

The SMF network element is mainly responsible for session management in a mobile network, for example, session establishment, modification, and release. A specific function is, for example, allocating an internet protocol (IP) address to a user, or selecting a UPF that provides a packet forwarding function.

The PCF network element mainly supports providing a unified policy framework to control network behavior, and providing a policy rule for a control layer network function, and is responsible for obtaining user subscription information related to a policy decision. The PCF network element may provide a policy, such as a quality of service (QoS) policy and a slice selection policy, for the AMF network element and the SMF network element. Based on layers or functions, the PCF network element may be divided into a plurality of entities, for example, a global PCF and a PCF in a slice, or a session management PCF (SM-PCF) and an access management PCF (AM-PCF).

The AF network element mainly supports interaction with a 3GPP core network to provide a service, for example, affecting a data routing decision or a policy control function, or providing some third-party services for a network side.

The NEF network element may be configured to perform protocol conversion on interaction between the external and the internal, for example, perform protocol conversion on interaction between a 3GPP external network element and a 3GPP internal network element (for example, the SMF network element). A 3GPP network may be a network defined in the 3GPP protocol, for example, a network including an access network and a core network, such as a mobile communications network, a public land mobile network (PLMN), or a non-public network (NPN), and may be a 5^{th} generation (5^{th} generation, 5G) communications network or a future evolved mobile communications network.

The data network (DN) may be configured to provide a data transmission service for a terminal. UE may access the data network by using an established protocol data unit (PDU) session. The data network may be a public data network (PDN), such as the internet, or may be a local access data network (LADN), such as a network of a mobile edge computing (MEC) node.

In the architecture shown in FIG. 1a, a network element in a dashed-line box is a service-oriented NF network element, an interface between NF network elements is a service-oriented interface, and an exchanged message is a service-oriented message.

2. Data Source

For each data source, management data about the data source may be generated in an OAM system. In embodiments of this application, the data source may include one or more of the following: a network slice, a network slice subnet, a network element, a subnet including the network element, an interface of the network element, or configuration data of the network element. The management data of the data source may be specifically performance statistics data of the network slice, the network slice subnet, or the network element, or alarm information data. When the data source is the interface of the network element or the configuration data of the network element, the management data is a specific value of a configuration item of the network element, or a specific value of a configuration item of the interface of the network element.

The network slice is an end-to-end logical network obtained by abstracting a physical network. One physical network may be abstracted into a plurality of network slices, and the network slices are isolated and do not affect each other. The network slice may be identified by using single network slice selection assistance information (S-NSSAI). A network may select a network slice for a service based on S-NSSAI carried in a service request of a terminal, and establish a packet data unit (PDU) session in the selected network slice, to transmit service data.

The network slice subnet is a radio subnet part or a core network part that forms the network slice. The radio subnet part that forms the network slice is referred to as a network slice access network subnet, and the core network part that forms the network slice is referred to as a network slice core network subnet. The network slice access network subnet may be understood as an instance of an access network part in the network slice, and the network slice core network subnet may be understood as an instance of a core network part in the network slice. One network slice may include one or more network slice core network subnets. The network slice core network subnet may be identified by using a network slice instance identifier (NSI ID) in a network.

For example, the interface of the network element is an N4 interface between an SMF and a UPF. The configuration data of the network element is a 5G quality of service identifier (QI) set preconfigured in the SMF. The 5QI set includes two preconfigured 5QIs, which are separately 5QI=1 and 5QI=5.

The network element may be a network element in the network slice or the network slice subnet, or may not be a network element in the network slice or the network slice subnet.

3. Identifier of a Data Source

The identifier of the data source identifies the data source. When the data source is a network slice, the identifier of the data source may be network slice selection assistance information (for example, S-NSSAI), and identifies the network slice. When the data source is a network slice subnet, the identifier of the data source may be a network slice subnet identifier, and identifies the network slice subnet. Specifically, when the data source is a network slice access network subnet, the identifier of the data source may be S-NSSAI. When the data source is a network slice core network subnet, the identifier of the data source may be S-NSSAI+NSI ID. When the data source is a network element, the identifier of the data source may be an identifier of the network element. For example, when the data source is an AMF, the identifier of the data source is an AMF ID.

The network slice subnet identifier may also be referred to as a network slice instance identifier. The S-NSSAI may be configured for the network slice after the network slice is created in an OAM system. The NSI ID may be configured for the network slice core network subnet after the network slice core network subnet is created in an OAM system. In this application, the network slice core network subnet may also be referred to as a core network slice subnet. Similarly, the network slice access network subnet may also be referred to as an access network slice subnet.

4. Object Identifier that is of a Data Source and that is in an OAM System

The object identifier that is of the data source and that is in the OAM system may identify the data source in the OAM system. The data source may be managed as a managed object instance (MOI) inside the OAM system. The object identifier that is of the data source and that is in the OAM system may specifically identify, in the OAM system, an MOI that is of the data source and that is in the OAM system.

For example, a wireless network in a southern area of a city is managed as a subnet, and the wireless network may be referred to as a southern subnet for short. The wireless network includes three wireless devices (a, b, and c). The wireless device a is a base station device that can provide both a 4G (eNB) function and a 5G (gNB) function. An area covered by the base station device may be divided into a plurality of cells. It is assumed that the wireless device a provides the 4G function by using an eNB 1 and provides the 5G function by using a gNB 1, and an area covered by the gNB 1 is divided into two cells (a cell 1 and a cell 2). MOIs that are of the foregoing data sources (the southern subnet, the three wireless devices, the eNB 1, the gNB 1, the cell 1, and the cell 2) in the southern subnet and that are in the OAM system may form a tree structure. A schematic diagram of the tree structure may be shown in FIG. 1B. Each node in the tree structure is an MOI.

The MOI in the OAM system may further have different attributes. For example, a network slice has an S-NSSAI attribute, and a core network subnet slice has an NSI ID attribute. Different access network slice subnets may have different coverage. Each gNB may include one or more cells. An SMF and a UPF may be configured with respective service areas. An AMF may be configured with a tracking area (TA) list as a service area of the AMF.

For example, a network slice includes an access network slice subnet 1 and an access network slice subnet 2. The access network slice subnet 1 includes a gNB 1 and a gNB 2, and the gNB 1 is configured with a cell 1 and a cell 2. The access network slice subnet 2 includes a gNB 3 and a gNB 4. The network slice further includes a core network slice subnet 1 and a core network slice subnet 2. The core network slice subnet 1 includes an SMF 1, a UPF 1, and an AMF. The core network slice subnet 2 includes the AMF, an SMF 2, and a UPF 2. MOIs that are of the foregoing data sources (the network slice, the access network slice subnet 1, the access network slice subnet 2, the core network slice subnet 1, and the core network slice subnet 2) in the network slice and that are in the OAM system may form a tree structure. A schematic diagram of the tree structure may be shown in FIG. 1c. In FIG. 1c, a white filled box represents an MOI, and a gray filled box represents an attribute of an MOI. In this application, after a new network slice or network slice subnet is created in the OAM system, a tree structure that is of the network slice or the network slice subnet and that is in the OAM system may be created. The tree structure includes an MOI that is of the network slice or the network slice subnet and that is in the OAM system.

In embodiments of this application, the MOI may be identified by using a distinguished name (DN). To be specific, the object identifier that is of the data source and that is in the OAM system is a DN of the MOI that is of the data source and that is in the OAM system. It should be noted that all DNs mentioned below are distinguished names.

It should be noted that, for ease of description, in this embodiment of this application, the object identifier that is of the data source and that is in the OAM system may be referred to as an object identifier of the data source for short. For example, a DN of an MOI that is of a network slice and that is in the OAM system may be referred to as a DN of the network slice for short, a DN of an MOI that is of a network slice subnet and that is in the OAM system may be referred to as a DN of the network slice subnet for short, and a DN of an MOI that is of a network element and that is in the OAM system may be referred to as a DN of the network element for short. The DN of the network slice may be an object identifier generated for the network slice when the network slice is created in the OAM system. The DN of the network slice subnet may be an object identifier generated for the network slice subnet when the network slice subnet is created in the OAM system.

The DN may include one or more relative distinguished names (RDNs). In an implementation, the plurality of RDNs included in the DN may form an RDN list. For example, in the RDN list, the RDNs may be separated by using a comma (“,”).

Optionally, the DN may include two types of RDNs. A first-type RDN is located on a leftmost side of the RDN list that forms the DN, and this type of RDN may be referred to as a domain component (DC). A value of the DC may be a domain name. The DN including the DC is globally unique. Optionally, the DN may include one DC. A second-type RDN is an RDN except the DC in the DN. The DN may include one or more second-type RDNs. A value of the second-type RDN is related to the MOI identified by the DN.

For example, the cell 1 in FIG. 1B is used as an example. A DN of an MOI corresponding to the cell 1 is as follows:

DN=“DC=operatorA.com, subNetwork=south, managedElement=a, gNBFunction=1, cell=1”.

A value of a DC is a domain name operatorA.com. “subNetwork=south” indicates that the cell 1 is a cell in the southern subnet. “managedElement=a” indicates that the cell 1 is a cell obtained through division by using a base station function provided by the wireless device a. “gNBFunction=1” indicates that the cell 1 is a cell obtained through division from the area covered by the gNB 1. “cell=l” indicates that an identifier of the cell 1 is 1. In conclusion, the DN indicates that the cell 1 is a cell that is obtained through division from the area covered by the gNB 1 provided by the wireless device a in the southern subnet and whose identifier is 1.

5. OAM System

The OAM system may include one or more of the following network elements: a network function management function (NFMF), a network slice management function (NSMF), and a network slice subnet management function (NSSMF).

The NFMF is for managing a network element in the OAM system. When a service or an interface of the OAM system needs to be invoked to obtain management data of a network element, specifically, in the OAM system, a service or an interface of the NFMF may be invoked to obtain the management data of the network element. For example, if an NWDAF needs to obtain configuration information of an NSSF, when a configuration management service or interface of the OAM system is invoked to obtain the configuration information, a configuration management service or interface provided by the NFMF may be specifically invoked. If the NWDAF needs to obtain overload alarm information of an SMF, when an alarm management service or interface of the OAM system is invoked to obtain the overload alarm information, an alarm management service or interface provided by the NFMF may be specifically invoked.

The NSMF is for managing a network slice in the OAM system. When a service or an interface of the OAM system needs to be invoked to obtain management data of a network slice, specifically, in the OAM system, a service or an interface of the NSMF may be invoked to obtain the management data of the network slice. For example, if an NWDAF needs to obtain key performance indicator (KPI) information of a network slice, when a performance management service or interface of the OAM system is invoked to obtain the KPI information, a performance management service or interface provided by the NSMF may be specifically invoked.

The NSSMF is for managing a network slice subnet in the OAM system. When a service or an interface of the OAM system needs to be invoked to obtain management data of a network slice subnet, specifically, in the OAM system, a service or an interface of the NSSMF may be invoked to obtain the management data of the network slice subnet. For example, if an NWDAF needs to obtain KPI information of a network slice subnet, when a performance management service or interface of the OAM system is invoked to obtain the KPI information, a performance management service or interface provided by the NSSMF may be specifically invoked. It should be noted that, the network slice may be specifically created by the NSMF. Similarly, the network slice subnet may be specifically created by the NSSMF.

It should be noted that, if a service or an interface provided by the OAM system needs to be invoked to obtain management data of a data source, a DN of an MOI that is of the data source and that is in the OAM system, namely, an object identifier that is of the data source and that is in the OAM system, needs to be provided. For example, if an NWDAF needs to obtain configuration information of an NSSF, the NWDAF needs to provide a DN of an MOI that is of the NSSF and that is in the OAM system, to invoke a configuration management service or interface of the OAM system to obtain the configuration information. If the NWDAF needs to obtain KPI information of a network slice or a network slice subnet, the NWDAF needs to provide a DN of an MOI that is of the network slice or the network slice subnet and that is in the OAM system, to invoke a performance management service or interface of the OAM system to obtain the KPI information. It should be further noted that, in this application, data that is of the data source and that is obtained from the OAM system may also be referred to as the management data of the data source.

Currently, if an NWDAF needs to obtain management data of a managed object in an OAM system, the NWDAF needs to have an entire database of managed objects of the OAM system, searches, starting from a root node of an entire tree structure that is formed by the managed objects and that is similar to that shown in FIG. 1c, for the managed object corresponding to a data source in the OAM system, and obtains the data of the managed object. As a result, a process in which the NWDAF obtains the data of the managed object from the OAM system is complex.

In view of this, this application provides a data obtaining method and system, and an apparatus thereof, to simplify the process in which the NWDAF obtains the data of the managed object from the OAM system.

FIG. 1d is a schematic diagram of a system architecture to which an embodiment of this application is applied. The system architecture may include a network data analytics network element 101 and an OAM system 102. The network data analytics network element 101 may be the NWDAF network element in FIG. 1a.

The network data analytics network element 101 may be configured to determine a data source to which to-be-obtained data belongs; obtain first information; and determine, based on the first information, an object identifier that is of the data source and that is in an OAM system. The object identifier that is of the data source and that is in the OAM system may be a DN of an MOI that is of the data source and that is in the OAM system. After determining the object identifier, the network data analytics network element 101 is further configured to send a first request to the OAM system. The first request includes the object identifier, and the first request is for requesting to obtain the to-be-obtained data.

The OAM system 102 is configured to obtain the to-be-obtained data based on the object identifier in the first request after receiving the first request from the network data analytics network element 101, and may further send the obtained to-be-obtained data to the network data analytics network element 101.

The first information may include the following information.

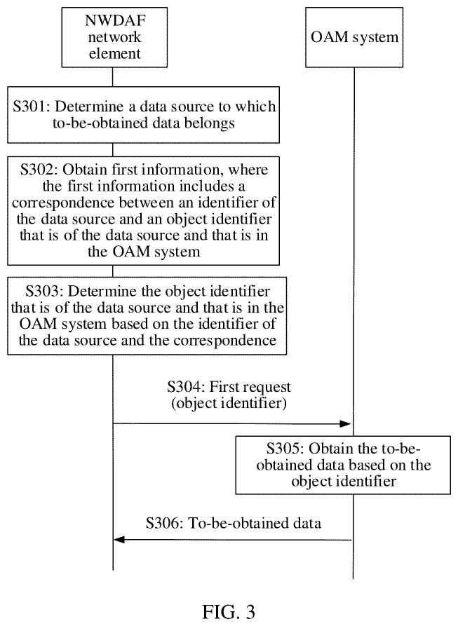

In a first implementation, the first information may include a correspondence between an identifier of the data source and the object identifier that is of the data source and that is in the OAM system. For specific descriptions of the correspondence, refer to descriptions in an embodiment corresponding to FIG. 3.

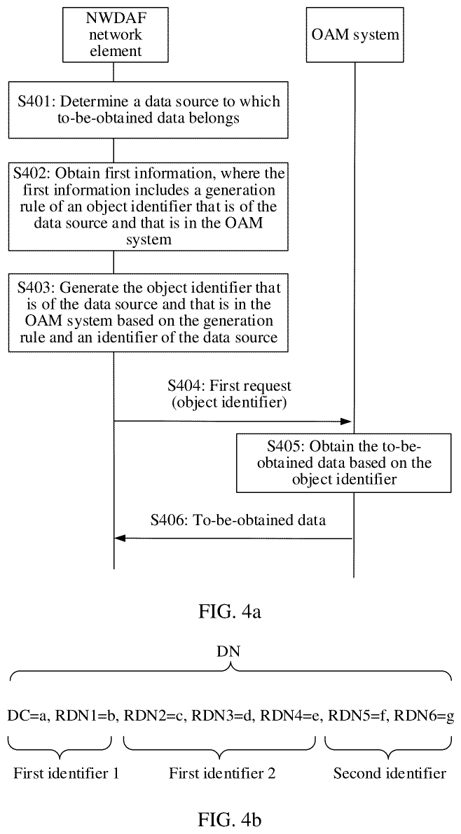

In a second implementation, the first information may include a generation rule of generating, based on an identifier of the data source, the object identifier that is of the data source and that is in the OAM system. For specific descriptions of the generation rule, refer to descriptions in an embodiment corresponding to FIG. 4a.

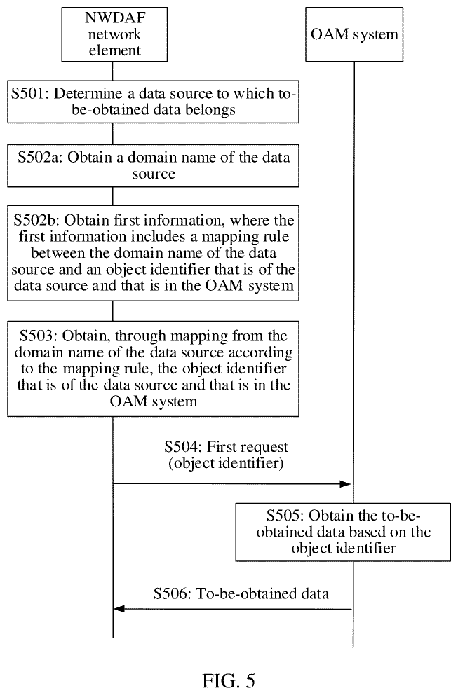

In a third implementation, the first information may include a mapping rule between a domain name of the data source and the object identifier that is of the data source and that is in the OAM system. For specific descriptions of the mapping rule, refer to descriptions in an embodiment corresponding to FIG. 5.

The network data analytics network element 101 may determine, based on the first information, the object identifier that is of the data source and that is in the OAM system. In this manner, the network data analytics network element 101 does not need to obtain an entire database of managed objects of the OAM system, so that a process in which the network data analytics network element obtains data of a managed object from the OAM system is simplified.

It should be noted that, it can be learned from the foregoing that the first information may be for associating the identifier of the data source with the object identifier that is of the data source and that is in the OAM system, or may be for associating the domain name of the data source with the object identifier that is of the data source and that is in the OAM system. The first information may also be referred to as association information.

The technologies described in embodiments of this application may be applied to various communications systems, for example, a 4th generation (4G) communications system, a 4.5G communications system, a 5G communications system, a system integrating a plurality of communications systems, or a future evolved communications system such as a 6G communications system. It should be noted that a network element name, a message name, and the like mentioned in embodiments of this application are used as examples, and are applied to different communications systems. The network element name and the message name may be different. This is not limited in embodiments of this application.

It can be understood that the communications system described in embodiments of this application is used to describe the technical solution in embodiments of this application more clearly, but does not limit the technical solution provided in embodiments of this application. A person skilled in the art may learn that with evolution of a system architecture and emergence of a new service scenario, the technical solutions provided in embodiments of this application is also applicable to a similar technical problem.

The following describes in detail the data obtaining method and system, and the apparatus thereof that are provided in this application with reference to the accompanying drawings. It should be noted that, in descriptions of the data obtaining method, an example in which a network data analytics network element is an NWDAF network element and a network slice selection network element is an NSSF network element is used for description. For ease of description, two words “network element” are not shown in figures corresponding to embodiments, and the two words “network element” are not indicated in specific descriptions of embodiments. However, this does not affect understanding of embodiments of this application. It should further be noted that names of messages between network elements, names of parameters in the messages, or the like in the following embodiments of this application are merely examples, and there may be other names in a specific implementation. This is not specifically limited in embodiments of this application.

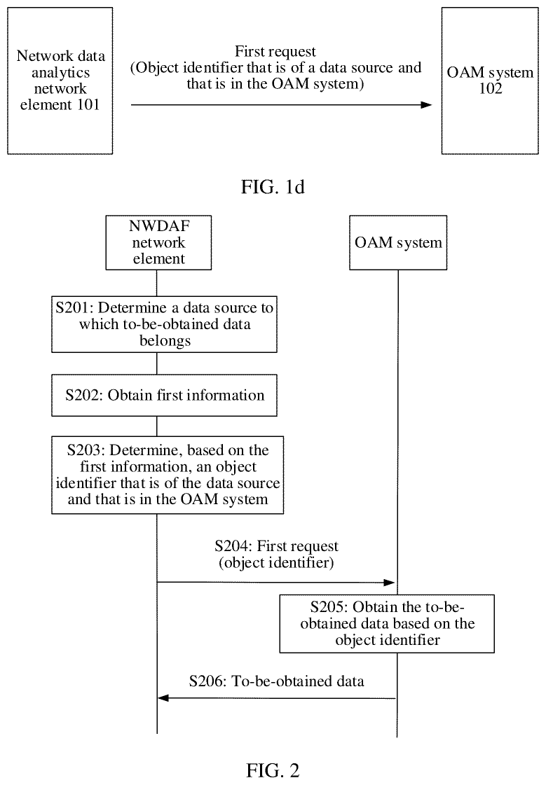

FIG. 2 is a schematic flowchart of a data obtaining method according to an embodiment of this application. As shown in FIG. 2, the method may include but is not limited to the following steps.

Step S201: An NWDAF network element determines a data source to which to-be-obtained data belongs.

The to-be-obtained data may be configuration data of a network element, performance statistics data, a KPI of a network slice, or a KPI of a network slice subnet.

In this embodiment of this application, when determining that the to-be-obtained data needs to be obtained from an OAM system, the NWDAF network element determines the data source to which the to-be-obtained data belongs. In an implementation, the NWDAF network element may receive a second request, where the second request is for requesting to perform data analytics; and determine, based on the second request, the data source to which the to-be-obtained data belongs.

In a possible implementation, the second request includes an identifier of the data source. To be specific, a data source indicated by an identifier carried in the second request is the data source to which the to-be-obtained data belongs. Optionally, in this case, the data source may include a network slice and/or a network slice subnet. The identifier of the data source carried in the second request may include network slice selection assistance information (S-NSSAI) and/or a network slice subnet identifier (NSI ID).

In another possible implementation, the NWDAF network element may analyze the second request, to determine the data source to which the to-be-obtained data belongs. In this manner, the second request does not carry the identifier of the data source. For example, if the second request is for requesting to count a quantity of quality of service (QoS) flows of a 5G quality of service identifier (5QI), and the 5QI is preconfigured by an SMF network element, the NWDAF network element analyzes the second request, and may determine that the data source to which the to-be-obtained data belongs is configuration data of the SMF network element. The configuration data of the SMF network element includes a 5QI set preconfigured by the SMF network element.

A sender of the second request may be a network element or a terminal device. This is not limited in this embodiment of this application.

Step S202: The NWDAF network element obtains first information.

The first information is for determining an object identifier that is of the data source to which the to-be-obtained data belongs and that is in the OAM system. In this embodiment of this application, the NWDAF network element may obtain the first information in any one of the following manners.

Manner 1: The NWDAF network element obtains the first information from the OAM system or an NRF network element.

In Manner 1, the OAM system or the NRF network element may actively send the first information to the NWDAF network element. Alternatively, the NWDAF network element may send a request 1 to the OAM system or the NRF network element, to request to obtain the first information. After receiving the request 1, the OAM system or the NRF network element sends the first information to the NWDAF network element.

The NRF network element may obtain the first information from the OAM system or an NSSF network element, and then send the first information to the NWDAF network element. The NSSF network element may obtain the first information from the OAM system, and then send the first information to the NRF network element. In other words, in Manner 1, the first information may be actually from the OAM system. The OAM system may generate the first information, and send the first information to a first network element. The first network element may be the NWDAF network element, the NSSF network element, or the NRF network element. To be specific, the OAM system may directly send the first information to the NWDAF network element, or send the first information to the NWDAF network element via one or more network elements (namely, the NRF network element, or the NSSF network element and the NRF network element). Optionally, the OAM system may send a configuration command to the first network element, where the configuration command includes the first information.

Manner 2: The NWDAF network element obtains a network function profile (NF profile) from the OAM system or an NRF network element, where the network function profile includes the first information.

In Manner 2, the OAM system or the NRF network element may actively send the network function profile to the NWDAF network element. Alternatively, the NWDAF network element may send a request 2 to the OAM system or the NRF network element, to request to obtain the network function profile. After receiving the request 2, the OAM system or the NRF network element sends the network function profile to the NWDAF network element.

The NRF network element may obtain the network function profile from the OAM system or an NSSF network element, and then send the network function profile to the NWDAF network element. The NSSF network element may obtain the network function profile from the OAM system, and then send the network function profile to the NRF network element. In other words, in Manner 2, the network function profile may be actually from the OAM system. The OAM system may generate the network function profile, and send the network function profile to a first network element. The first network element may be the NWDAF network element, the NSSF network element, or the NRF network element. To be specific, the OAM system may directly send the network function profile to the NWDAF network element, or send the network function profile to the NWDAF network element via one or more network elements (namely, the NRF network element, or the NSSF network element and the NRF network element). The network function profile may be a configuration file of the NWDAF network element or a configuration file of the NSSF network element.

Manner 3: The NWDAF network element obtains the first information from a memory of the NWDAF network element. In other words, the NWDAF network element may locally obtain the first information. Optionally, the first information may be built in the NWDAF network element, or may be preconfigured in the NWDAF network element.

Step S203: The NWDAF network element determines, based on the first information, the object identifier that is of the data source and that is in the OAM system.

After obtaining the first information, the NWDAF network element may determine, based on the first information, the object identifier that is of the data source and that is in the OAM system. For example, when the first information includes a correspondence between an identifier of the data source and the object identifier that is of the data source and that is in the OAM system, the NWDAF network element may determine the object identifier that is of the data source and that is in the OAM system based on the identifier of the data source and the correspondence.

Step S204: The NWDAF network element sends a first request to the OAM system, where the first request includes the object identifier, and the first request is for requesting to obtain the to-be-obtained data. The OAM system receives the first request.

After determining the object identifier that is of the data source and that is in the OAM system, the NWDAF network element may send the first request to the OAM system, to request to obtain the to-be-obtained data. For example, the NWDAF network element uses the object identifier as a parameter to invoke a createMeasurementJob or subscribe service interface of the OAM system, so as to obtain performance statistics data or alarm information data of the data source. For another example, the NWDAF network element uses the object identifier as a parameter to invoke a getMOIAttribute service interface of the OAM system, so as to obtain a specific value of a configuration item that is of the data source and that is in the OAM system.

Step S205: The OAM system obtains the to-be-obtained data based on the object identifier.

After receiving the first request, the OAM system may obtain the to-be-obtained data based on the object identifier in the first request.

It should be noted that the OAM system includes a management device. In embodiments of this application, steps performed by the OAM system may be specifically performed by the management device. When the data source is a network element, an interface of the network element, or configuration data of the network element, the management device may be the foregoing NFMF. In this case, the NWDAF network element may specifically invoke the getMOIAttribute service interface of the NFMF by using the object identifier as a parameter. Similarly, when the data source is a network slice, the management device may be the foregoing NSMF. In this case, the NWDAF network element may specifically invoke the createMeasurementJob or subscribe service interface of the NSMF by using the object identifier as a parameter. When the data source is a network slice subnet, the management device may be the foregoing NSSMF. In this case, the NWDAF network element may specifically invoke the createMeasurementJob or subscribe service interface of the NSSMF by using the object identifier as a parameter.

Step S206: The OAM system sends the to-be-obtained data to the NWDAF network element.

After obtaining the to-be-obtained data, the OAM system may send the to-be-obtained data to the NWDAF network element. Correspondingly, after receiving the to-be-obtained data, the NWDAF network element may perform data analytics based on the to-be-obtained data, to obtain an analytics result. Optionally, the NWDAF network element may send the analytics result to the sender of the second request.

Specifically, if the data source to which the to-be-obtained data belongs is a network slice, an NSMF in the OAM system may obtain the to-be-obtained data, and send the to-be-obtained data to the NWDAF network element. If the data source to which the to-be-obtained data belongs is a network slice subnet, an NSSMF in the OAM system may obtain the to-be-obtained data, and send the to-be-obtained data to the NWDAF network element. If the data source to which the to-be-obtained data belongs is a network element (or an interface of the network element or configuration data of the network element), an NFMF in the OAM system may obtain the to-be-obtained data, and send the to-be-obtained data to the NWDAF network element.

In this embodiment of this application, the NWDAF network element may determine, based on the first information, the object identifier that is of the data source and that is in the OAM system. In this manner, the NWDAF network element does not need to obtain an entire database of managed objects of the OAM system, so that a process in which the NWDAF network element obtains data from the OAM system is simplified. In addition, the NWDAF network element does not obtain the entire database of managed objects of the OAM system, so that the NWDAF network element does not have a right of viewing all network management data. This helps ensure network element security.

FIG. 3 is a schematic flowchart of another data obtaining method according to an embodiment of this application. In this embodiment, a data source is a network slice or a network slice subnet. In the method, how an NWDAF network element determines an object identifier that is of the data source and that is in an OAM system based on a correspondence between an identifier of the data source and the object identifier that is of the data source and that is in the OAM system is described in detail. The method may include but is not limited to the following steps.

Step S301: An NWDAF network element determines a data source to which to-be-obtained data belongs.

It should be noted that, for an execution process of step S301, refer to specific descriptions of step S201 in FIG. 2. Details are not described herein again.

Step S302: The NWDAF network element obtains first information, where the first information includes a correspondence between an identifier of the data source and an object identifier that is of the data source and that is in an OAM system.

For a manner in which the NWDAF network element obtains the first information, refer to specific descriptions of step S202 in FIG. 2. Details are not described herein again.

The identifier of the data source in the first information may identify a network slice or a network slice subnet. The identifier of the data source may include network slice selection assistance information and/or a network slice subnet identifier. The object identifier that is of the data source and that is in the OAM system may include a managed object identifier relating to network slice managed object identifier and/or a managed object identifier relating to network slice subnet.

For example, the identifier of the data source in the first information identifies a network slice, an identifier of the network slice is S-NSSAI, and the object identifier is a DN. The correspondence may be shown in Table 1.

TABLE 1
Correspondence

| Identifier of | Object identifier that is of the data |
|---|---|
| the data source | source and that is in the OAM system |
| S-NSSAI 1 | DN 1 |
| S-NSSAI 2 | DN 2 |

It can be learned from Table 1 that, after obtaining the identifier of the data source to which the to-be-obtained data belongs, the NWDAF network element may determine the object identifier that is of the data source and that is in the OAM system by querying Table 1. Optionally, the NWDAF network element may obtain the identifier of the data source from the second request. For details, refer to the descriptions of step S201 in FIG. 2. Details are not described herein again.

Refer to the descriptions of step S202 in FIG. 2. It can be learned that the first information is actually from the OAM system. It should be noted that, if the NWDAF network element is not expected, based on a permission control and security requirement of network management, to obtain data of a network slice or a network slice subnet, after the network slice or the network slice subnet is created in the OAM system, a correspondence between an identifier of the network slice and an object identifier that is of the network slice and that is in the OAM system may not be configured, or a correspondence between an identifier of the network slice subnet and an object identifier that is of the network slice subnet and that is in the OAM system may not be configured in the OAM system. In this way, the NWDAF network element cannot obtain the object identifier of the network slice or the network slice subnet from the first information, and cannot further obtain DNs of a slice subnet and each network element that are included in the network slice (or cannot obtain a DN of each network element included in the newly created network slice subnet). Therefore, the NWDAF network element cannot invoke a management service interface provided by the OAM system to obtain data of the network slice or the network slice subnet, so that an objective of network security and permission control is achieved.

In an implementation, the first information may be included in a network function profile. The network function profile may include but is not limited to one or more of the following: a correspondence (for example, referred to as a correspondence 1) between an identifier of the network slice and an object identifier that is of the network slice and that is in the OAM system; a correspondence (for example, referred to as a correspondence 2) between an identifier of the network slice and an object identifier that is of the network slice subnet in the network slice and that is in the OAM system; a correspondence (for example, referred to as a correspondence 3) between an identifier of the network slice subnet in the network slice and an object identifier that is of the network slice and that is in the OAM system; or a correspondence (for example, referred to as a correspondence 4) between an identifier of the network slice subnet in the network slice and an object identifier that is of the network slice subnet and that is in the OAM system. Optionally, the correspondence 3 may be specifically a correspondence between an identifier of a core network slice subnet in the network slice and the object identifier that is of the network slice and that is in the OAM system. The correspondence 4 may be specifically a correspondence between an identifier of a core network slice subnet in the network slice and an object identifier that is of the core network slice subnet and that is in the OAM system.

For example, if the network function profile includes the correspondence 1, a specific form of the correspondence included in the network function profile may be: S-NSSAI: {DN of the network slice}.

In the correspondence 2, an identifier of a network slice may correspond to an object identifier that is of one or more network slice subnets (for example, an access network slice subnet and/or a core network slice subnet) in the network slice and that is in the OAM system. To be specific, after obtaining the correspondence 2 and the identifier of the network slice, the NWDAF network element may learn of the object identifier that is of the network slice subnet in the network slice and that is in the OAM system. For example, the identifier of the network slice is S-NSSAI, and the object identifier is a DN. One piece of S-NSSAI may correspond to a DN that is of one or more network slice subnets and that is in the OAM system.

For example, if the network function profile includes the correspondence 1 and the correspondence 2, the specific form of the correspondence included in the network function profile may be: S-NSSAI: {DN of the network slice, DN of one or more AN slice subnets, DN of one or more CN slice subnets}. When the specific form is applied to the tree structure shown in FIG. 1c, the correspondence included in the network function profile is: S-NSSAI #1: {DN of the network slice, DN of the AN slice subnet 1 and DN of the AN slice subnet 2, DN of the CN slice subnet 1 and DN of the CN slice subnet 2}, or S-NSSAI #1: {DN of the network slice, DN list of AN slice subnets: {DN of the AN slice subnet 1, DN of the AN slice subnet 2}, DN list of CN slice subnets: {DN of the CN slice subnet 1, DN of the CN slice subnet 2}}.

For example, if the network function profile includes the correspondence 3, and the identifier of the network slice subnet is S-NSSAI+NSI ID, the specific form of the correspondence included in the network function profile may be: S-NSSAI+NSI ID: {DN of the network slice}.

For example, if the network function profile includes the correspondence 4, and the correspondence 4 is specifically the correspondence between the identifier of the core network slice subnet in the network slice and the object identifier that is of the core network slice subnet and that is in the OAM system, the specific form of the correspondence included in the network function profile may be: S-NSSAI+NSI ID: {DN of the CN slice subnet}. When the specific form is applied to the tree structure shown in FIG. 1c, the correspondence included in the network function profile is: {S-NSSAI #1+NSI ID #1: DN of the CN slice subnet 1; S-NSSAI #1+NSI ID #2: DN of the CN slice subnet 2}.

For example, if the network function profile includes the correspondence 1, the correspondence 2, and the correspondence 4, and the correspondence 4 is specifically the correspondence between the identifier of the core network slice subnet in the network slice and the object identifier that is of the core network slice subnet and that is in the OAM system, the specific form of the correspondence included in the network function profile may be: S-NSSAI: {DN of the network slice, {NSI ID: DN of the CN slice subnet} }. When the specific form is applied to the tree structure shown in FIG. 1c, the correspondence included in the network function profile is: S-NSSAI #1: {DN of the network slice, DN list (optional) of AN slice subnets, DN list of CN slice subnets: {NSI ID #1: DN of the CN slice subnet 1; NSI ID #2: DN of the CN slice subnet 2}}.

If the network function profile includes one or more of the correspondence 1, the correspondence 2, the correspondence 3, and the correspondence 4, the NWDAF network element may select a required correspondence from the correspondences based on a determined data source, and then perform a subsequent step.

Step S303: The NWDAF network element determines the object identifier that is of the data source and that is in the OAM system based on the identifier of the data source and the correspondence.

After obtaining the identifier of the data source to which the to-be-obtained data belongs, the NWDAF network element may determine the object identifier that is of the data source and that is in the OAM system by querying Table 1.

It can be learned from the foregoing that, the network function profile may include one or more of the correspondence 1, the correspondence 2, the correspondence 3, and the correspondence 4. If the data source to which the to-be-obtained data belongs is the network slice subnet, the NWDAF network element may determine the object identifier that is of the data source and that is in the OAM system based on the identifier of the data source and the correspondence 4 in the network function profile.

Step S304: The NWDAF network element sends a first request to the OAM system, where the first request includes the object identifier, and the first request is for requesting to obtain the to-be-obtained data.

Step S305: The OAM system obtains the to-be-obtained data based on the object identifier.

Step S306: The OAM system sends the to-be-obtained data to the NWDAF network element.

It should be noted that, for an execution process of step S304 to step S306, refer to specific descriptions of step S204 to step S206 in FIG. 2. Details are not described herein again.

In this embodiment of this application, the NWDAF network element may determine the object identifier that is of the data source and that is in the OAM system based on the correspondence between the identifier of the data source and the object identifier that is of the data source and that is in the OAM system. In this manner, the NWDAF network element does not need to obtain an entire database of managed objects of the OAM system, so that a process in which the NWDAF network element obtains data from the OAM system is simplified. In addition, the NWDAF network element does not obtain the entire database of managed objects of the OAM system, so that the NWDAF network element does not have a right of viewing all network management data. This helps ensure network element security.

FIG. 4a is a schematic flowchart of still another data obtaining method according to an embodiment of this application. In this embodiment, a data source is a network slice or a network slice subnet. In the method, how an NWDAF network element generates an object identifier that is of the data source and that is in an OAM system based on an identifier of the data source and a generation rule of the object identifier that is of the data source and that is in the OAM system is described in detail. The method may include but is not limited to the following steps.

Step S401: An NWDAF network element determines a data source to which to-be-obtained data belongs.

It should be noted that, for an execution process of step S401, refer to specific descriptions of step S201 in FIG. 2. Details are not described herein again.

Step S402: The NWDAF network element obtains first information, where the first information includes a generation rule of an object identifier that is of the data source and that is in an OAM system.

For a manner in which the NWDAF network element obtains the first information, refer to specific descriptions of step S202 in FIG. 2. Details are not described herein again.

The first information specifically includes a generation rule of generating, based on an identifier of the data source, the object identifier that is of the data source and that is in the OAM system. The NWDAF network element may obtain the identifier of the data source from the second request. For details, refer to the descriptions of step S201 in FIG. 2. Details are not described herein again.

For example, the object identifier is a DN, the DN includes one or more RDNs, the RDN includes an RDN name and a value of the RDN name, and the identifier of the data source includes a value of the identifier of the data source. The generation rule included in the first information may be: using the value of the identifier of the data source as the value of the RDN name. Specifically, if the data source is a network slice, the generation rule may be using a value of an identifier (namely, a value of S-NSSAI) of the network slice as the value of the RDN name. For example, S-NSSAI xxx indicates that the value of the identifier (the S-NSSAI) of the network slice is “xxx”, and an RDN name in a DN of the network slice includes “networkslice”. In this case, an RDN generated based on the generation rule is “networkslice=xxx”.

If the data source is a core network slice subnet, the generation rule may be using a value of an identifier (namely, a value of S-NSSAI and a value of an NSI ID) of the core network slice subnet as the value of the RDN name. Specifically, the generation rule may be using the value of the S-NSSAI of the core network slice subnet as a value of an RDN name, and using the value of the NSI ID of the core network slice subnet as a value of another RDN name. For example, S-NSSAI xxx and NSI ID yy indicate that the value of the S-NSSAI of the core network slice subnet is xxx, and the value of the NSI ID of the core network slice subnet is yy. An RDN name in a DN of the core network slice subnet includes “networkslice” and “networkslicesubnet”. In this case, one RDN generated based on the generation rule is “networkslice=xxx”, and the other RDN is “networkslicesubnet=y” or “networkslicesubnet=CN-yy”.

If the data source is an access network slice subnet, the generation rule may be using a value of an identifier (namely, a value of S-NSSAI) of a network slice to which the access network slice subnet belongs as the value of the RDN name. Specifically, the generation rule may be using the value of the S-NSSAI of the access network slice subnet as a value of an RDN name, and using the value of the S-NSSAI of the access network slice subnet as a value of another RDN name. For example, S-NSSAI xxx indicates that the value of the S-NSSAI of the access network slice subnet is xxx, and a value of an identifier of the access network slice subnet is also xxx. An RDN name in a DN of the access network slice subnet includes “networkslice” and “networkslicesubnet”. In this case, one RDN generated based on the generation rule is “networkslice=xxx”, and the other RDN is “networkslicesubnet=xxx”, “networkslicesubnet=RAN-xxx”, or “networkslicesubnet=AN-xxx”.

It should be noted that, in the foregoing descriptions, an uppercase letter represents the identifier of the network slice, and a lowercase letter represents the RDN name, to facilitate distinguishing between the identifier of the network slice and the RDN name. The uppercase letter and the lowercase letter are merely used as an example. During specific implementation, the identifier of the network slice and the RDN name may be the same.

Step S403: The NWDAF network element generates the object identifier that is of the data source and that is in the OAM system based on the generation rule and the identifier of the data source.

Specifically, after obtaining the generation rule and the identifier of the data source, the NWDAF network element may generate the object identifier that is of the data source and that is in the OAM system based on the generation rule and the identifier of the data source.

In an implementation, the object identifier that is of the data source and that is in the OAM system includes a first identifier and a second identifier, and the generation rule includes a first generation rule and a second generation rule. The first generation rule may include a rule of generating the first identifier based on a domain name of the NWDAF network element. The second generation rule may include a rule of generating the second identifier based on the identifier of the data source. It may be understood that the NWDAF network element may generate the first identifier based on the first generation rule and the domain name of the NWDAF network element, and generate the second identifier based on the second generation rule and the identifier of the data source.

The object identifier that is of the data source and that is in the OAM system may include a DC and an RDN set, and the RDN set includes one or more RDNs. The first identifier may include the DC and first one or more neighboring RDNs in the RDN set, and the second identifier may include last one or more RDNs in the RDN set. The first identifier and the second identifier form the DC and the RDN set. In other words, a position of the first identifier in the DN is before a position of the second identifier in the DN. For content of the second generation rule, refer to specific descriptions of step S402. Details are not described herein again.

First generation rule: Generate the first identifier based on first n levels of domain names of the NWDAF network element. n is an integer greater than or equal to 2. Specifically, the first generation rule is: using first two levels of domain names of the NWDAF network element as the DC, and respectively using each level of domain name from the 3^{rd} level of domain name to first n levels of domain name of the NWDAF network element as a value of each RDN name in the first identifier. A value of n may be determined by the OAM system, or may be agreed on in a protocol. This is not limited in this embodiment of this application.

For example, if the domain name of the NWDAF network element is “nwdaf.5gc.mnc001.mcc460.3gppnetwork.org”, and n=4, first two levels of domain names “3gppnetwork.org” of the NWDAF network element are used as the DC, to obtain “DC=3gppnetwork.org”, and each level of domain name from the 3^{rd} level of domain name (namely, “mcc460”) of the NWDAF network element to first four levels of domain names (namely, “mnc001”) of the NWDAF network element is respectively used as the value of each RDN name in the first identifier, to obtain “MCC=460, MNC=001”. Therefore, the first identifier generated according to the first generation rule is “DC=3gppnetwork.org, MCC=460, MNC=001”.

For example, after the network slice and the network slice subnet are created in the OAM system, if S-NSSAI 567 and an NSI ID abc are configured for the NWDAF network element in the OAM system, the NWDAF network element may generate the following according to the second generation rule and the first generation rule in the foregoing example:
DN of the network slice: “DC=3gppnetwork.org, MCC=460, MNC=001, networkslice=567”.
DN of the access network slice subnet: “DC=3gppnetwork.org, MCC=460, MNC=001, networkslice=567, networkslicesubnet=RAN-567”.
DN of the core network slice subnet: “DC=3gppnetwork.org, MCC=460, MNC=001, networkslice=567, networkslicesubnet=CN-abc”.

Optionally, the first identifier may specifically include a first identifier 1 and a first identifier 2. The first generation rule includes a first generation rule 1 and a first generation rule 2. The first generation rule 1 may include a rule of generating the first identifier 1 based on the domain name of the NWDAF network element. For details, refer to the foregoing descriptions about the first generation rule and the first identifier. The first generation rule 2 may include a rule of generating the first identifier 2 based on a host name of the NWDAF network element. It may be understood that the NWDAF network element may generate the first identifier 1 based on the first generation rule 1 and the domain name of the NWDAF network element; generate the first identifier 2 based on the first generation rule 2 and the host name of the NWDAF network element; and generate the second identifier based on the second generation rule and the identifier of the data source.

The first identifier 1 may include the DC and first one or more neighboring RDNs in the RDN set. The first identifier 2 may include one or more RDNs that are in the RDN set and that are adjacent to the RDN in the first identifier 1. The second identifier may be one or more RDNs that are in the RDN set and that are adjacent to the first identifier 2. For a schematic diagram of compositions of the object identifier that is of the data source and that is in the OAM system, refer to FIG. 4b. In FIG. 4b, an example in which the first identifier 1 includes one RDN, the first identifier 2 includes three RDNs, and the second identifier includes two RDNs is used.

The host name includes one or more segments of characters that are separated by using “.”. Optionally, the first generation rule 2 may be: using a letter part in each segment of character strings separated by using “.” in the host name of the NWDAF network element as the RDN name, and using a numeric part in each segment of character strings as the value of the RDN name.

For example, if the host name of the NWDAF network element is “nwdaf1. managedElement1”, the first identifier 2 generated based on the host name may be “managedElement=1, NWDAFID=1”. managedElement may be a physical device configured to manage the NWDAF network element. In another implementation, managedElement may not exist. Optionally, whether the physical device managedElement configured to manage the NWDAF network element exist may depend on deployment of an operator. It should be noted that, that the host name includes a specific network element (for example, the NWDAF network element) is used as an example. In another feasible implementation, the host name may alternatively include an interface or configuration data of a network element.

The domain name of the NWDAF network element may be a fully qualified domain name (FQDN). The FQDN is a name that includes both a host name and a domain name, where the host name and the domain name are connected by using punctuation “.”. For example, when the host name is bigserver and the domain name is mycompany.com, the FQDN is bigserver.mycompany.com.

Step S404: The NWDAF network element sends a first request to the OAM system, where the first request includes the object identifier, and the first request is for requesting to obtain the to-be-obtained data.

Step S405: The OAM system obtains the to-be-obtained data based on the object identifier.

Step S406: The OAM system sends the to-be-obtained data to the NWDAF network element.

It should be noted that, for an execution process of step S504 to step S506, refer to specific descriptions of step S204 to step S206 in FIG. 2. Details are not described herein again.

In this embodiment of this application, the NWDAF network element may generate the object identifier that is of the data source and that is in the OAM system based on the identifier of the data source and the generation rule of the object identifier that is of the data source and that is in the OAM system. In this manner, the NWDAF network element does not need to obtain an entire database of managed objects of the OAM system, so that a process in which the NWDAF network element obtains data from the OAM system is simplified. In addition, the NWDAF network element does not obtain the entire database of managed objects of the OAM system, so that the NWDAF network element does not have a right of viewing all network management data. This helps ensure network element security. In addition, when the data source is a network slice or a network slice subnet, even if a network slice or a network slice subnet is newly added, an object identifier that is of the (newly added) network slice or network slice subnet and that is in the OAM system may be generated according to the historically obtained generation rule.

FIG. 5 is a schematic flowchart of still another data obtaining method according to an embodiment of this application. In this embodiment, a data source is a network element, an interface of the network element, or configuration data of the network element. In the method, how an NWDAF network element obtains, through mapping according to a mapping rule between a domain name of the data source and an object that is of the data source and that is in an OAM system, the object identifier that is of the data source and that is in the OAM system is described in detail. The method may include but is not limited to the following steps.

Step S501: An NWDAF network element determines a data source to which to-be-obtained data belongs.

It should be noted that, for an execution process of step S501, refer to specific descriptions of step S201 in FIG. 2. Details are not described herein again.

Step S502a: The NWDAF network element obtains a domain name of the data source.

In an implementation, the NWDAF network element may obtain the domain name of the data source in the following manner:

The NWDAF network element sends a third request to an NRF network element, where the third request is for requesting to obtain the domain name of the data source; and the NWDAF network element receives the domain name of the data source from the NRF network element. Alternatively, if the data source is the NWDAF network element, the NWDAF network element may obtain the domain name of the NWDAF network element from a memory of the NWDAF network element.

It should be noted that, if the NWDAF network element is not expected, based on a permission control and security requirement of network management, to obtain data of a network element, when the network element is configured in the OAM system, only an IP address but not a domain name may be provided. In this way, information registered by the network element with the NRF network element does not include the domain name of the network element, and the NWDAF network element cannot obtain the domain name of the network element from the NRF network element. Further, the NWDAF network element cannot obtain an object identifier that is of the network element and that is in the OAM system. The NWDAF network element cannot invoke a management service interface provided by the OAM system to obtain the data of the network element, so that an objective of network security and permission control is achieved.

Step S502b: The NWDAF network element obtains first information, where the first information includes a mapping rule between the domain name of the data source and an object identifier that is of the data source and that is in an OAM system.

For a manner in which the NWDAF network element obtains the first information, refer to specific descriptions of step S202 in FIG. 2. Details are not described herein again.

The mapping rule may be: mapping first m levels of domain names of the data source to the object identifier that is of the data source and that is in the OAM system. The object identifier that is of the data source and that is in the OAM system may include a DC and an RDN set, and the RDN set includes one or more RDNs. Specifically, the mapping rule may be: obtaining the DC from first two levels of domain names of the data source through mapping, and respectively obtaining a value of each RDN name in the object identifier that is of the data source and that is in the OAM system through mapping from each level of domain name from the 3rd level of domain name to first m levels of domain names of the data source. A value of m may be determined by the OAM system, or may be agreed on in a protocol. This is not limited in this embodiment of this application.

For example, if the data source is an SMF network element, a domain name of the SMF network element is “smf.5gc.mnc001.mcc460.3gppnetwork.org”, and m=4, “DC=3gppnetwork.org” may be obtained through mapping from first two levels of domain names “3gppnetwork.org” of the SMF network element; “MCC=460” is obtained through mapping from the 3^{rd} level of domain name (namely, “mcc460”) of the SMF network element; and “MNC=001” is obtained through mapping from the 4th level of domain name (namely, “mnc001”) of the SMF network element. Therefore, the object identifier obtained through mapping according to the mapping rule is “DC=3gppnetwork.org, MCC=460, MNC=001”.

Alternatively, the mapping rule may be specifically: mapping a domain name “south.subNetwork.operatorA.com” to DC=operatorA.com, subNetwork=south.subNetwork is an RDN name.

It should be noted that an execution sequence of step S502a and step S502b is not limited in this embodiment of this application. Step S502a or step S502b may be performed first, or step S502a and step S502b may be performed simultaneously.

Step S503: The NWDAF network element obtains, through mapping from the domain name of the data source according to the mapping rule, the object identifier that is of the data source and that is in the OAM system.

In an implementation, the object identifier that is of the data source and that is in the OAM system may include a third identifier and a fourth identifier. The first information may specifically include a first mapping rule between the domain name of the data source and the third identifier and a second mapping rule between a host name of the data source and the fourth identifier. For details of the first mapping rule, refer to the foregoing descriptions about the mapping rule. It may be understood that the NWDAF network element may obtain the host name of the data source; obtain the third identifier through mapping from the domain name of the data source according to the first mapping rule; and obtain the fourth identifier through mapping from the host name of the data source according to the second mapping rule.

The object identifier that is of the data source and that is in the OAM system may include a DC and an RDN set, and the RDN set includes one or more RDNs. The third identifier may include the DC and first one or more neighboring RDNs in the RDN set, and the fourth identifier may include last one or more RDNs in the RDN set. The third identifier and the fourth identifier form the DC and the RDN set. In other words, a position of the third identifier in the DN is before a position of the fourth identifier in the DN.

The host name includes one or more segments of characters that are separated by using “.”. Optionally, the first generation rule 2 may be: using a letter part in each segment of character strings separated by using “.” in the host name of the data source as the RDN name, and using a numeric part in each segment of character strings as the value of the RDN name. The domain name of the data source may be a fully qualified domain name (FQDN). The FQDN includes both a host name and a domain name.

For example, if the data source is an SMF network element, an FQDN of the SMF network element is “smf1.managedElement1.south.subNetwork.operatorA.com”, and m=4. a third identifier that is of the SMF network element, that is in the OAM system, and that is obtained through mapping according to the first mapping rule may be “DC=operatorA.com, subNetwork=south”. A fourth identifier that is of the SMF network element, that is in the OAM system, and that is obtained through mapping according to the second mapping rule may be “managedElement=1, SMF=1”. managedElement may be a physical device configured to manage the SMF network element. In another implementation, managedElement may not exist. Optionally, whether the physical device managedElement configured to manage the SMF network element exist may depend on deployment of an operator. It should be noted that, that the host name includes a specific network element (for example, the SMF network element) is used as an example. In another feasible implementation, the host name may alternatively include an interface or configuration data of a network element. For example, the host name includes an N4 interface 1 (N4Inf1.smf1.managedElement1) between an SMF 1 and a UPF. Alternatively, the host name includes a 5QI set 1 (5QIset1. smf1.managedElement1) preconfigured on an SMF 1. The 5QI set 1 includes two preconfigured 5QIs, where one 5QI=1, and the other 5QI=5.

Step S504: The NWDAF network element sends a first request to the OAM system, where the first request includes the object identifier, and the first request is for requesting to obtain the to-be-obtained data.

Step S505: The OAM system obtains the to-be-obtained data based on the object identifier.

Step S506: The OAM system sends the to-be-obtained data to the NWDAF network element.

It should be noted that, for an execution process of step S504 to step S506, refer to specific descriptions of step S204 to step S206 in FIG. 2. Details are not described herein again.

In an implementation, if the to-be-obtained data is a 5QI set configured by an SMF network element, after obtaining the 5QI set, the NWDAF network element may further obtain, from the OAM system, a performance statistics indicator corresponding to the 5QI, for example, a quantity of QoS flows of each 5QI.

The NWDAF network element may obtain, from the OAM system, configuration data of each NF including an access network element, for example, information such as a cell list configured by a gNB, a service area configured by an SMF, an S-NSSAI list and an NSI ID list configured by an NSSF, or a capacity and a deployment location of a UPF. The NWDAF network element may use the data obtained from the OAM system as input data for data analytics.

It should be noted that, if the NWDAF network element obtains a DN of an MOI that is of the data source and that is in the OAM system, it may indicate that the NWDAF network element obtains DNs of all sub-MOIs that use the MOI as a vertex and that are in a tree structure to which the MOI belongs in the OAM system. For example, in FIG. 1B, if the NWDAF network element obtains a DN that is of the wireless device a (one MOI) and that is in the OAM system, it indicates that the NWDAF network element obtains DNs that are of MOIs such as the wireless device a, the eNB 1, the gNB 1, the cell 1, and the cell 2 and that are in the OAM system.

In this embodiment of this application, the NWDAF network element may obtain, through mapping from the domain name of the data source according to the mapping rule between the domain name of the data source and the object identifier that is of the data source and that is in the OAM system, the object identifier that is of the data source and that is in the OAM system. In this manner, the NWDAF network element does not need to obtain an entire database of managed objects of the OAM system, so that a process in which the NWDAF network element obtains data from the OAM system is simplified. In addition, the NWDAF network element does not obtain the entire database of managed objects of the OAM system, so that the NWDAF network element does not have a right of viewing all network management data. This helps ensure network element security.

Corresponding to the methods provided in the foregoing method embodiments, an embodiment of this application further provides a corresponding apparatus. The apparatus includes a corresponding module configured to perform the foregoing embodiments. The module may be software, hardware, or a combination of software and hardware.

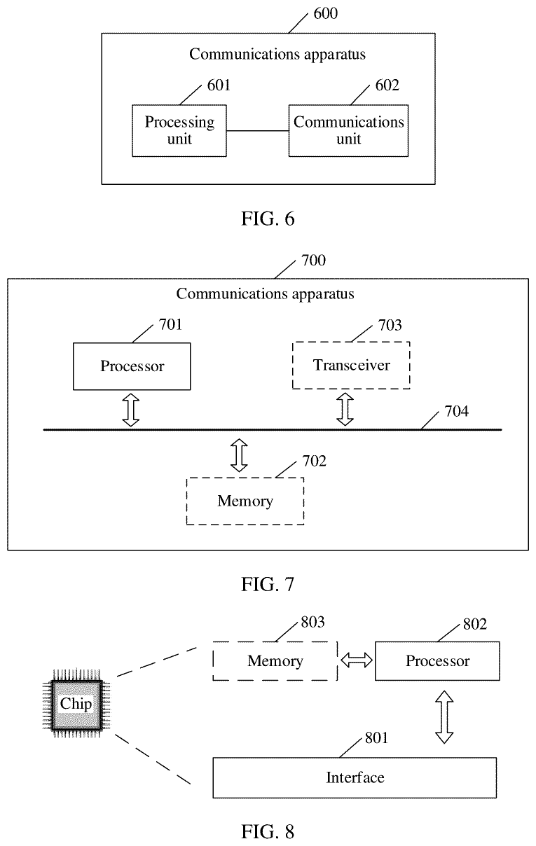

FIG. 6 is a schematic diagram of a structure of a communications apparatus according to this application. The communications apparatus 600 shown in FIG. 6 includes a processing unit 601 and a communications unit 602.

In a design, the apparatus 600 is a network data analytics network element.

For example, the processing unit 601 is configured to determine a data source to which to-be-obtained data belongs, obtain first information, and determine, based on the first information, an object identifier that is of the data source and that is in an operation, administration, and maintenance OAM system. The communications unit 602 is configured to send a first request to the OAM system, where the first request includes the object identifier, and the first request is for requesting to obtain the to-be-obtained data.

In an implementation, the first information includes a correspondence between an identifier of the data source and the object identifier that is of the data source and that is in the OAM system.

In an implementation, the data source includes a network slice or a network slice subnet.

In an implementation, the first information is included in a network function profile. The network function profile includes one or more of the following: a correspondence between an identifier of the network slice and an object identifier that is of the network slice and that is in the OAM system; a correspondence between an identifier of the network slice and an object identifier that is of the network slice subnet in the network slice and that is in the OAM system; a correspondence between an identifier of the network slice subnet in the network slice and an object identifier that is of the network slice and that is in the OAM system; or a correspondence between an identifier of the network slice subnet in the network slice and an object identifier that is of the network slice subnet and that is in the OAM system.

In an implementation, the to-be-obtained data is a key performance indicator KPI of the network slice or a KPI of the network slice subnet.

In an implementation, the first information includes a generation rule of the object identifier that is of the data source and that is in the OAM system. When being configured to determine, based on the first information, the object identifier that is of the data source and that is in the OAM system, the processing unit 601 is specifically configured to generate, based on the generation rule and an identifier of the data source, the object identifier that is of the data source and that is in the OAM system.

In an implementation, the object identifier includes a first identifier and a second identifier, and the generation rule includes a first generation rule and a second generation rule. When being configured to generate, based on the generation rule and an identifier of the data source, the object identifier that is of the data source and that is in the OAM system, the processing unit 601 is specifically configured to generate the first identifier based on the first generation rule and a domain name of the network data analytics network element, and generate the second identifier based on the second generation rule and the identifier of the data source.

In an implementation, an identifier of the data source includes network slice selection assistance information and/or a network slice subnet identifier. The object identifier that is of the data source and that is in the OAM system includes a managed object identifier relating to network slice managed object identifier and/or a managed object identifier relating to network slice subnet.

In an implementation, the communications unit 602 is further configured to receive a second request, where the second request is for requesting to perform data analytics. The communications unit 602 is further configured to receive the to-be-obtained data from the OAM system. The processing unit 601 is further configured to perform data analytics based on the to-be-obtained data, to obtain an analytics result. When being configured to determine a data source to which to-be-obtained data belongs, the processing unit 601 is specifically configured to determine, based on the second request, the data source to which the to-be-obtained data belongs.

In an implementation, the second request includes an identifier of the data source.

In an implementation, the first information includes a mapping rule between a domain name of the data source and the object identifier that is of the data source and that is in the OAM system. The processing unit 601 is further configured to obtain the domain name of the data source. When being configured to determine, based on the first information, an object identifier that is of the data source and that is in an OAM system, the processing unit 601 is specifically configured to obtain, through mapping from the domain name of the data source according to the mapping rule, the object identifier that is of the data source and that is in the OAM system.

In an implementation, the object identifier includes a third identifier and a fourth identifier. The first information specifically includes a first mapping rule between the domain name of the data source and the third identifier and a second mapping rule between a host name of the data source and the fourth identifier. The processing unit 601 is further configured to obtain the host name of the data source. When being configured to obtain, through mapping from the domain name of the data source according to the mapping rule, the object identifier that is of the data source and that is in the OAM system, the processing unit 601 is specifically configured to obtain the third identifier through mapping from the domain name of the data source according to the first mapping rule, and obtain the fourth identifier through mapping from the host name of the data source according to the second mapping rule.

In an implementation, when being configured to obtain the domain name of the data source, the processing unit 601 is specifically configured to invoke the communications unit 602 to send a third request to a network repository function NRF network element, where the third request is for requesting to obtain the domain name of the data source; and invoke the communications unit 602 to receive the domain name of the data source from the NRF network element.

In an implementation, when being configured to obtain first information, the processing unit 601 is specifically configured to obtain the first information from the OAM system or the NRF network element; obtain a network function profile from the OAM system or the NRF network element, where the network function profile includes the first information; or obtain the first information from a memory of the communications apparatus 600.

In an implementation, the network function profile is a configuration file of the communications apparatus 600 or a configuration file of a network slice selection network element.

When the apparatus 600 is the network data analytics network element, the apparatus 600 is configured to implement a function of the network data analytics network element in embodiments shown in FIG. 2 to FIG. 5.

In a design, the apparatus 600 is a management device in an OAM system. For example, the processing unit 601 is configured to generate first information. The first information is for determining an object identifier that is of a data source to which to-be-obtained data belongs and that is in the OAM system. The communications unit 602 is configured to send the first information to a first network element.

In an implementation, the first information includes a correspondence between an identifier of the data source and the object identifier that is of the data source and that is in the OAM system.

In an implementation, the data source includes a network slice or a network slice subnet.

In an implementation, the first information is included in a network function profile, and the network function profile includes one or more of the following:
a correspondence between an identifier of the network slice and an object identifier that is of the network slice and that is in the OAM system; a correspondence between an identifier of the network slice and an object identifier that is of the network slice subnet in the network slice and that is in the OAM system; a correspondence between an identifier of the network slice subnet in the network slice and an object identifier that is of the network slice and that is in the OAM system; or a correspondence between an identifier of the network slice subnet in the network slice and an object identifier that is of the network slice subnet and that is in the OAM system.

In an implementation, the to-be-obtained data is a key performance indicator KPI of the network slice or a KPI of the network slice subnet.

In an implementation, the first information includes a generation rule of the object identifier that is of the data source and that is in the OAM system.

In an implementation, the object identifier includes a first identifier and a second identifier. The generation rule includes a first generation rule and a second generation rule. The first generation rule includes a rule of generating the first identifier based on a domain name of a network data analytics network element. The second generation rule includes a rule of generating the second identifier based on an identifier of the data source.

In an implementation, an identifier of the data source includes network slice selection assistance information and/or a network slice subnet identifier. The object identifier that is of the data source and that is in the OAM system includes a managed object identifier relating to network slice managed object identifier and/or a managed object identifier relating to network slice subnet.

In an implementation, the first information includes a mapping rule between a domain name of the data source and the object identifier that is of the data source and that is in the OAM system.

In an implementation, the object identifier includes a third identifier and a fourth identifier. The first information specifically includes a first mapping rule between the domain name of the data source and the third identifier and a second mapping rule between a host name of the data source and the fourth identifier.

In an implementation, when being configured to send the first information to a first network element, the communications unit 602 is specifically configured to send a configuration command to the first network element, where the configuration command includes the first information; or send network function profile to the first network element, where the network function profile includes the first information.

In an implementation, the network function profile is a configuration file of the network data analytics network element or a network slice selection network element.

In an implementation, the first network element includes one or more of the following: the network slice selection network element, a network repository function NRF network element, or the network data analytics network element.

When the apparatus 600 is the management device in the OAM system, the apparatus 600 is configured to implement a function of the management device in embodiments shown in FIG. 2 to FIG. 5.

FIG. 7 is a schematic diagram of a structure of another communications apparatus according to this application. The communications apparatus 700 shown in FIG. 7 includes at least one processor 701, a memory 702, and a transceiver 703.

The memory 702 may be a volatile memory, for example, a random access memory. Alternatively, the memory may be a non-volatile memory, for example, a read-only memory, a flash memory, a hard disk drive (HDD), or a solid-state drive (SSD). Alternatively, the memory 702 is any other medium that can be used to carry or store expected program code in an instruction or a data structure form and that can be accessed by a computer. However, this is not limited thereto. The memory 702 may be a combination of the foregoing memories.

A specific connection medium between the processor 701, the memory 702, and the transceiver 703 is not limited in this embodiment of this application. In this embodiment of this application, the transceiver 703, the memory 702, and the processor 701 are connected by using a bus 704 in the figure. The bus 704 is represented by using a bold line in the figure. A connection manner between other components is merely an example for description, and is not limited thereto. The bus 704 may be classified into an address bus, a data bus, a control bus, and the like. For ease of representation, only one bold line is used for representation in FIG. 7, but this does not mean that there is only one bus or only one type of bus.

The processor 701 may have a data sending/receiving function, and can communicate with another device. In the apparatus shown in FIG. 7, an independent data communications unit, for example, the transceiver 703, may also be disposed and is configured to send/receive data. When communicating with the another device, the processor 701 may perform data transmission by using the transceiver 703.

It should be noted that, a dashed-line box in FIG. 7 indicates that the transceiver 703 may be disposed separately from the processor 701, or the transceiver 703 may be integrated into the processor 701; and the memory 702 may be disposed separately from the processor 701, or the memory 702 may be integrated into the processor 701.

In an example, when the form shown in FIG. 7 is used for a network data analytics network element, the processor in FIG. 7 may invoke computer-executable instructions stored in the memory 702, to enable the network data analytics network element to perform the method performed by the network data analytics network element in any one of the foregoing method embodiments.

In an example, when the form shown in FIG. 7 is used for a management device in an OAM system, the processor in FIG. 7 may invoke computer-executable instructions stored in the memory 702, to enable the management device to perform the method performed by the management device in any one of the foregoing method embodiments.

Specifically, functions/implementation processes of both the processing unit and the communications unit in FIG. 6 may be implemented by the processor 701 in FIG. 7 by invoking the computer-executable instructions stored in the memory 702. Alternatively, a function/implementation process of the processing unit in FIG. 6 may be implemented by the processor 701 in FIG. 7 by invoking the computer-executable instructions stored in the memory 702, and a function/implementation process of the communications unit in FIG. 6 may be implemented by the transceiver 703 in FIG. 7.

In an implementation, the communications apparatus 700 may include a circuit, and the circuit may implement a sending, receiving, or communications function in the foregoing method embodiments. The processor described in this application may be implemented in the following manners: an integrated circuit (IC), an analog IC, a radio frequency integrated circuit RFIC, a mixed signal IC, an application-specific integrated circuit (ASIC), a printed circuit board (PCB), an electronic device, or the like. The processor may alternatively be manufactured by using the following IC craft technologies, for example, a complementary metal-oxide-semiconductor (CMOS), an N-type metal oxide semiconductor (NMOS), a P-channel metal oxide semiconductor (PMOS), a bipolar junction transistor (BJT), a bipolar CMOS (BiCMOS), silicon germanium (SiGe), or gallium arsenide (GaAs).

The communications apparatus described in the foregoing embodiments may be the network data analytics network element or the management device in the OAM system. However, a scope of the communications apparatus described in this application is not limited thereto, and the structure of the communications apparatus may not be limited by FIG. 7. The communications apparatus may be an independent device or may be a part of a large device. For example, the communications apparatus may be:
(1) an independent integrated circuit IC, a chip, or a chip system or subsystem;
(2) a set including one or more ICs, where optionally, the set of ICs may further include a storage component configured to store data and a computer program;
(3) an ASIC such as a modem;
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) others.

For a case in which the communications apparatus may be the chip or the chip system, refer to a schematic diagram of a structure of a chip shown in FIG. 8. The chip shown in FIG. 8 includes an interface 801 and a processor 802. There may be one or more interfaces 801, and there may be a plurality of processors 802.

For a case in which the chip is configured to implement a function of the network data analytics network element in embodiments of this application:

The processor 802 is configured to determine a data source to which to-be-obtained data belongs, obtain first information, and determine, based on the first information, an object identifier that is of the data source and that is in an operation, administration, and maintenance OAM system. The interface 801 is configured to send a first request to the OAM system, where the first request includes the object identifier, and the first request is for requesting to obtain the to-be-obtained data.

In an implementation, the first information includes a correspondence between an identifier of the data source and the object identifier that is of the data source and that is in the OAM system.

In an implementation, the data source includes a network slice or a network slice subnet.

In an implementation, the first information is included in a network function profile. The network function profile includes one or more of the following: a correspondence between an identifier of the network slice and an object identifier that is of the network slice and that is in the OAM system; a correspondence between an identifier of the network slice and an object identifier that is of the network slice subnet in the network slice and that is in the OAM system; a correspondence between an identifier of the network slice subnet in the network slice and an object identifier that is of the network slice and that is in the OAM system; or a correspondence between an identifier of the network slice subnet in the network slice and an object identifier that is of the network slice subnet and that is in the OAM system.

In an implementation, the to-be-obtained data is a key performance indicator KPI of the network slice or a KPI of the network slice subnet.

In an implementation, the first information includes a generation rule of the object identifier that is of the data source and that is in the OAM system. When being configured to determine, based on the first information, the object identifier that is of the data source and that is in the OAM system, the processor 802 is specifically configured to generate, based on the generation rule and an identifier of the data source, the object identifier that is of the data source and that is in the OAM system.

In an implementation, the object identifier includes a first identifier and a second identifier, and the generation rule includes a first generation rule and a second generation rule. When being configured to generate, based on the generation rule and an identifier of the data source, the object identifier that is of the data source and that is in the OAM system, the processor 802 is specifically configured to generate the first identifier based on the first generation rule and a domain name of the network data analytics network element, and generate the second identifier based on the second generation rule and the identifier of the data source.

In an implementation, an identifier of the data source includes network slice selection assistance information and/or a network slice subnet identifier. The object identifier that is of the data source and that is in the OAM system includes a managed object identifier relating to network slice managed object identifier and/or a managed object identifier relating to network slice subnet.

In an implementation, the interface 801 is further configured to receive a second request, where the second request is for requesting to perform data analytics. The interface 801 is further configured to receive the to-be-obtained data from the OAM system. The processor 802 is further configured to perform data analytics based on the to-be-obtained data, to obtain an analytics result. When being configured to determine a data source to which to-be-obtained data belongs, the processor 802 is specifically configured to determine, based on the second request, the data source to which the to-be-obtained data belongs.

In an implementation, the second request includes an identifier of the data source.

In an implementation, the first information includes a mapping rule between a domain name of the data source and the object identifier that is of the data source and that is in the OAM system. The processor 802 is further configured to obtain the domain name of the data source. When being configured to determine, based on the first information, an object identifier that is of the data source and that is in an OAM system, the processor 802 is specifically configured to obtain, through mapping from the domain name of the data source according to the mapping rule, the object identifier that is of the data source and that is in the OAM system.

In an implementation, the object identifier includes a third identifier and a fourth identifier. The first information specifically includes a first mapping rule between the domain name of the data source and the third identifier and a second mapping rule between a host name of the data source and the fourth identifier. The processor 802 is further configured to obtain the host name of the data source. When being configured to obtain, through mapping from the domain name of the data source according to the mapping rule, the object identifier that is of the data source and that is in the OAM system, the processor 802 is specifically configured to obtain the third identifier through mapping from the domain name of the data source according to the first mapping rule, and obtain the fourth identifier through mapping from the host name of the data source according to the second mapping rule.

In an implementation, when being configured to obtain the domain name of the data source, the processor 802 is specifically configured to invoke the interface 801 to send a third request to a network repository function NRF network element, where the third request is for requesting to obtain the domain name of the data source; and invoke the interface 801 to receive the domain name of the data source from the NRF network element.

In an implementation, when being configured to obtain first information, the processor 802 is specifically configured to obtain the first information from the OAM system or the NRF network element; obtain a network function profile from the OAM system or the NRF network element, where the network function profile includes the first information; or obtain the first information from a memory of the communications apparatus.

In an implementation, the network function profile is a configuration file of the communications apparatus or a configuration file of a network slice selection network element.

Specifically, in this case, for operations performed by the interface 801 and the processor 802, refer to descriptions about the network data analytics network element in embodiments corresponding to FIG. 2 to FIG. 5.

For a case in which the chip is configured to implement a function of the management device in the OAM system in embodiments of this application:

The processor 802 is configured to generate first information. The first information is for determining an object identifier that is of a data source to which to-be-obtained data belongs and that is in the OAM system. The interface 801 is configured to send the first information to a first network element.

In an implementation, the first information includes a correspondence between an identifier of the data source and the object identifier that is of the data source and that is in the OAM system.

In an implementation, the data source includes a network slice or a network slice subnet.

In an implementation, the first information is included in a network function profile. The network function profile includes one or more of the following: a correspondence between an identifier of the network slice and an object identifier that is of the network slice and that is in the OAM system; a correspondence between an identifier of the network slice and an object identifier that is of the network slice subnet in the network slice and that is in the OAM system; a correspondence between an identifier of the network slice subnet in the network slice and an object identifier that is of the network slice and that is in the OAM system; or a correspondence between an identifier of the network slice subnet in the network slice and an object identifier that is of the network slice subnet and that is in the OAM system.

In an implementation, the to-be-obtained data is a key performance indicator KPI of the network slice or a KPI of the network slice subnet.

In an implementation, the first information includes a generation rule of the object identifier that is of the data source and that is in the OAM system.

In an implementation, the object identifier includes a first identifier and a second identifier. The generation rule includes a first generation rule and a second generation rule. The first generation rule includes a rule of generating the first identifier based on a domain name of a network data analytics network element. The second generation rule includes a rule of generating the second identifier based on an identifier of the data source.

In an implementation, an identifier of the data source includes network slice selection assistance information and/or a network slice subnet identifier. The object identifier that is of the data source and that is in the OAM system includes a managed object identifier relating to network slice managed object identifier and/or a managed object identifier relating to network slice subnet.

In an implementation, the first information includes a mapping rule between a domain name of the data source and the object identifier that is of the data source and that is in the OAM system.

In an implementation, the object identifier includes a third identifier and a fourth identifier. The first information specifically includes a first mapping rule between the domain name of the data source and the third identifier and a second mapping rule between a host name of the data source and the fourth identifier.

In an implementation, when being configured to send the first information to a first network element, the interface 801 is specifically configured to send a configuration command to the first network element, where the configuration command includes the first information; or send network function profile to the first network element, where the network function profile includes the first information.

In an implementation, the network function profile is a configuration file of the network data analytics network element or a network slice selection network element.

In an implementation, the first network element includes one or more of the following: the network slice selection network element, a network repository function NRF network element, or the network data analytics network element.

Specifically, in this case, for operations performed by the interface 801 and the processor 802, refer to descriptions about the management device in embodiments corresponding to FIG. 2 to FIG. 5.

Optionally, the chip further includes a memory 803, and the memory 803 is configured to store a computer program and data that are necessary. The memory 803 may be separately disposed, or may be integrated with the processor 802, as shown in a dashed-line box in FIG. 8.

A person skilled in the art may further understand that various illustrative logical blocks (illustrative logic blocks) and steps that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the scope of embodiments of this application.

An embodiment of this application further provides a data obtaining system. The system may include one or more of the network data analytics network element and the management device in the OAM system in embodiments corresponding to FIG. 2 to FIG. 5. Optionally, the system further includes the network slice selection network element and/or the network repository function NRF network element in embodiments corresponding to FIG. 2 to FIG. 5.

This application further provides a computer-readable storage medium. The computer-readable storage medium stores a computer program. The computer program product includes program instructions. When the program instructions are executed by a computer, a function of any one of the foregoing method embodiments is implemented.

The computer-readable storage medium includes but is not limited to a flash memory, a hard disk, and a solid-state drive.

This application further provides a computer program product. When the computer program product is executed by a computer, functions of any one of the foregoing method embodiments are implemented.

It may be understood that, in some scenarios, some optional features in embodiments of this application may be independently implemented without depending on another feature, for example, a solution on which the optional features are currently based, to resolve a corresponding technical problem and achieve a corresponding effect. Alternatively, in some scenarios, the optional features may be combined with other features based on requirements. Correspondingly, the apparatus provided in embodiments of this application may also correspondingly implement these features or functions. Details are not described herein.

A person skilled in the art may further understand that various illustrative logical blocks (illustrative logical blocks) and steps that are listed in embodiments of this application may be implemented by electronic hardware, computer software, or a combination thereof. Whether the functions are implemented by using hardware or software depends on particular applications and a design requirement of the entire system. A person skilled in the art may use various methods to implement the functions for corresponding application, but it should not be considered that the implementation goes beyond the protection scope of embodiments of this application.

The solutions described in this application may be implemented in various manners. For example, the technologies may be implemented by hardware, software, or a combination thereof. For hardware implementation, a processing unit configured to execute these technologies at a communications apparatus (for example, a base station, a terminal, a network entity, a core network element, or a chip) may be implemented in one or more general-purpose processors, digital signal processors (DSP), digital signal processor components, or application-specific integrated circuits (ASIC), programmable logic devices, field programmable gate arrays (FPGA), or another programmable logic apparatus, discrete gate or transistor logic, discrete hardware component, or any combination thereof. The general-purpose processor may be a microprocessor. Optionally, the general-purpose processor may also be any conventional processor, controller, microcontroller, or state machine. The processor may also be implemented by a combination of computing apparatuses, such as a digital signal processor and a microprocessor, multiple microprocessors, one or more microprocessors with a digital signal processor core, or any other similar configuration.

It may be understood that the memory in this embodiment of this application may be a volatile memory or a nonvolatile memory, or may include a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus dynamic random access memory (DR RAM). It should be noted that the memory of the systems and methods described in this specification includes but is not limited to these and any memory of another proper type.

All or some of the foregoing embodiments may be implemented by using software, hardware, firmware, or any combination thereof. When software is used to implement embodiments, all or a part of embodiments may be implemented in a form of a computer program product. The computer program product includes one or more computer instructions. When the computer instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another web site, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

It may be understood that “an embodiment” mentioned in the entire specification means that particular features, structures, or characteristics related to the embodiment are included in at least one embodiment of this application. Therefore, embodiments in the entire specification do not necessarily refer to a same embodiment. In addition, these particular features, structures, or characteristics may be combined in one or more embodiments by using any appropriate manner. It may be understood that sequence numbers of the foregoing processes do not mean an execution sequence in various embodiments of this application. The execution sequence of the processes should be determined based on functions and internal logic of the processes, and should not be construed as any limitation on the implementation processes of embodiments of this application.

It should be understood that, in this application, “when” and “if” mean that an apparatus performs corresponding processing in an objective situation, and are not intended to limit time. The terms do not mean that the apparatus is required to have a determining action during implementation, and do not mean any other limitation.

In this application, an element represented in a singular form is intended to represent “one or more”, but does not represent “only one”, unless otherwise specified. In this application, unless otherwise specified, “at least one” is intended to represent “one or more”, and “a plurality of” is intended to represent “two or more”.

In addition, the terms “system” and “network” may be used interchangeably in this specification. The term “and/or” in this specification describes only an association relationship between associated objects and represents that three relationships may exist. For example, A and/or B may represent the following three cases: only A exists, both A and B exist, and only B exists. A may be singular or plural, and B may be singular or plural.

“Predefine” in this application may be understood as “define”, “predefine”, “store”, “pre-store”, “pre-negotiate”, “pre-configure”, “solidify”, or “pre-burn”.

A person of ordinary skill in the art may understand that, for the purpose of convenient and brief description, for a detailed working process of the foregoing system, apparatuses, and units, refer to a corresponding process in the foregoing method embodiments. Details are not described herein again.

For same or similar parts in embodiments of this application, refer to each other. In embodiments of this application and the implementations/implementation methods/implementation manners in embodiments, unless otherwise specified or a logical conflict occurs, terms and/or descriptions are consistent and may be mutually referenced between different embodiments and between the implementations/implementation methods/implementation manners in embodiments. Technical features in the different embodiments and the implementations/implementation methods/implementation manners in embodiments may be combined to form a new embodiment, implementation, implementation manner, or implementation method based on an internal logical relationship thereof. The foregoing descriptions are implementations of this application, but are not intended to limit the protection scope of this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application.

What is claimed is:

1. A data obtaining method, wherein the method comprises:
determining, by a network data analytics network element, a data source to which to-be-obtained data belongs;
obtaining, by the network data analytics network element, first information;
determining, by the network data analytics network element based on the first information, an object identifier that is of the data source and that is in an operation, administration, and maintenance (OAM) system; and
sending, by the network data analytics network element, a first request to the OAM system, wherein the first request comprises the object identifier, and the first request is for requesting to obtain the to-be-obtained data.

2. The method according to claim 1, wherein the first information comprises a correspondence between an identifier of the data source and the object identifier that is of the data source and that is in the OAM system.

3. The method according to claim 2, wherein the data source comprises a network slice or a network slice subnet.

4. The method according to claim 3, wherein the first information is comprised in a network function profile, and the network function profile comprises one or more of the following:
a correspondence between an identifier of the network slice and an object identifier that is of the network slice and that is in the OAM system;
a correspondence between an identifier of the network slice and an object identifier that is of the network slice subnet in the network slice and that is in the OAM system;
a correspondence between an identifier of the network slice subnet in the network slice and an object identifier that is of the network slice and that is in the OAM system; or
a correspondence between an identifier of the network slice subnet in the network slice and an object identifier that is of the network slice subnet and that is in the OAM system.

5. The method according to claim 3, wherein the to-be-obtained data is a key performance indicator (KPI) of the network slice or a KPI of the network slice subnet.

6. The method according to claim 1, wherein:
the first information comprises a generation rule of the object identifier that is of the data source and that is in the OAM system; and the determining, by the network data analytics network element based on the first information, an object identifier that is of the data source and that is in an OAM system comprises:
generating, by the network data analytics network element based on the generation rule and an identifier of the data source, the object identifier that is of the data source and that is in the OAM system; or,
the first information comprises a mapping rule between a domain name of the data source and the object identifier that is of the data source and that is in the OAM system; and the determining, by the network data analytics network element based on the first information, an object identifier that is of the data source and that is in an OAM system comprises:
obtaining, by the network data analytics network element through mapping from the domain name of the data source according to the mapping rule, the object identifier that is of the data source and that is in the OAM system; and the method further comprises:
obtaining, by the network data analytics network element, the domain name of the data source.

7. The method according to claim 1, wherein an identifier of the data source comprises at least one of network slice selection assistance information or a network slice subnet identifier, and the object identifier that is of the data source and that is in the OAM system comprises at least one of a managed object identifier relating to network slice or a managed object identifier relating to network slice subnet.

8. The method according to claim 1, wherein the method further comprises:
receiving, by the network data analytics network element, a second request, wherein the second request is for requesting to perform data analytics;
receiving, by the network data analytics network element, the to-be-obtained data from the OAM system; and
performing, by the network data analytics network element, data analytics based on the to-be-obtained data, to obtain an analytics result,
wherein the determining, by a network data analytics network element, a data source to which to-be-obtained data belongs comprises: determining, by the network data analytics network element based on the second request, the data source to which the to-be-obtained data belongs.

9. The method according to claim 8, wherein the second request comprises an identifier of the data source.

10. A data obtaining method, applied to an operation, administration, and maintenance (OAM) system, wherein the system comprises a management device, and the method comprises:
generating, by the management device, first information, wherein the first information is for determining an object identifier that is of a data source to which to-be-obtained data belongs and that is in the OAM system; and
sending, by the management device, the first information to a first network element.

11. The method according to claim 10, wherein the first information comprises a correspondence between an identifier of the data source and the object identifier that is of the data source and that is in the OAM system.

12. The method according to claim 11, wherein the data source comprises a network slice or a network slice subnet.

13. The method according to claim 12, wherein the first information is comprised in a network function profile, and the network function profile comprises one or more of the following:
a correspondence between an identifier of the network slice and an object identifier that is of the network slice and that is in the OAM system;
a correspondence between an identifier of the network slice and an object identifier that is of the network slice subnet in the network slice and that is in the OAM system;
a correspondence between an identifier of the network slice subnet in the network slice and an object identifier that is of the network slice and that is in the OAM system; or
a correspondence between an identifier of the network slice subnet in the network slice and an object identifier that is of the network slice subnet and that is in the OAM system.

14. The method according to claim 12, wherein the to-be-obtained data is a key performance indicator (KPI) of the network slice or a KPI of the network slice subnet.

15. The method according to claim 10, wherein the first information comprises a generation rule of the object identifier that is of the data source and that is in the OAM system; or,
the first information comprises a mapping rule between a domain name of the data source and the object identifier that is of the data source and that is in the OAM system.

16. The method according to claim 15, wherein when the first information comprises a generation rule of the object identifier that is of the data source and that is in the OAM system, the object identifier comprises a first identifier and a second identifier, and the generation rule comprises a first generation rule and a second generation rule, wherein the first generation rule comprises a rule of generating the first identifier based on a domain name of a network data analytics network element, and the second generation rule comprises a rule of generating the second identifier based on an identifier of the data source;
or, when the first information comprises a mapping rule between a domain name of the data source and the object identifier that is of the data source and that is in the OAM system, the object identifier comprises a third identifier and a fourth identifier, and the first information comprises a first mapping rule between the domain name of the data source and the third identifier and a second mapping rule between a host name of the data source and the fourth identifier.

17. The method according to claim 10, wherein an identifier of the data source comprises at least one of network slice selection assistance information or a network slice subnet identifier, and the object identifier that is of the data source and that is in the OAM system comprises at least one of a managed object identifier relating to network slice or a managed object identifier relating to network slice subnet.

18. A communications apparatus, wherein the apparatus comprises at least one processor and at least one memory, the at least one memory is coupled to the at least one processor and stores program instructions, and the at least one processor executes the program instructions, to enable the apparatus to perform:
determining, by a network data analytics network element, a data source to which to-be-obtained data belongs;
obtaining, by the network data analytics network element, first information;
determining, by the network data analytics network element based on the first information, an object identifier that is of the data source and that is in an operation, administration, and maintenance (OAM) system; and
sending, by the network data analytics network element, a first request to the OAM system, wherein the first request comprises the object identifier, and the first request is for requesting to obtain the to-be-obtained data.

19. The communications apparatus according to claim 18, wherein the first information comprises a correspondence between an identifier of the data source and the object identifier that is of the data source and that is in the OAM system.

20. The communications apparatus according to claim 19, wherein the data source comprises a network slice or a network slice subnet.
